(19) United States
(12) Patent Application Publication
(10) Pub. No.: US 2025/0390737 A1
(43) Pub. Date: Dec. 25, 2025

(54) THERMODYNAMIC COMPUTING SYSTEM CONFIGURED TO UPDATE WEIGHTS AND BIASES BASED ON GRADIENT VALUES OBTAINED BY RELAY OSCILLATORS

(71) Applicant: Extropic Corp., Austin, TX (US)

(72) Inventors: Christopher Chamberland, Austin, TX (US); Guillaume Verdon-Akzam, San Francisco, CA (US)

(73) Assignee: Extropic Corp., Austin, TX (US)

(21) Appl. No.: 18/790,840

(22) Filed: Jul. 31, 2024

Related U.S. Application Data
(60) Provisional application No. 63/662,924, filed on Jun. 21, 2024.

(51) Int. Cl. G06N 3/08; G06N 3/0475; G06N 3/065

(52) U.S. Cl. CPC G06N 3/08; G06N 3/0475; G06N 3/065

(57) ABSTRACT

Systems, methods and computer readable media relating to a neuro-thermodynamic computers configured to train a learning model based on values representing gradient terms stored in position degrees of freedom of relay oscillators are described. An energy-based model comprising oscillators representing neurons and oscillators representing synapse values may be trained using gradient terms obtained in an analogue way. The gradient terms may be stored on respective relay oscillators and gradient terms may be combined with other gradient terms. Oscillators representing synapse parameters may be updated based on one or more gradient terms. In some embodiments, the training protocol is implemented in a fully analogue way. In some embodiments, measurements of relay oscillators are performed and stored in a classical computing device for post-processing.

### RELATED APPLICATION

This application claims benefit of priority to U.S. Provisional Application Ser. No. 63/662,924, entitled “Thermodynamic Computing System Configured to Determine Gradients Used to Update Weights and Biases Based On Expectation Values Captured by Relay Oscillators,” filed Jun. 21, 2024, and which is incorporated herein by reference in its entirety.

### BACKGROUND

### Description of Related Art

Various algorithms, such as machine learning algorithms, often use statistical probabilities to make decisions or to model systems. Some such learning algorithms may use Bayesian statistics, or may use other statistical models that have a theoretical basis in natural phenomena. Also, machine learning algorithms themselves may be implemented using Bayesian statistics, or may use other statistical models that have a theoretical basis in natural phenomena.

Generating such statistical probabilities may involve performing complex calculations which may require both time and energy to perform, thus increasing a latency of execution of the algorithm and/or negatively impacting energy efficiency. In some scenarios, calculation of such statistical probabilities using classical computing devices may result in non-trivial increases in execution time of algorithms and/or energy usage to execute such algorithms.

As an alternative, algorithms may be performed using thermodynamic computers. However, communication between multiple algorithms implemented on a thermodynamic computing device and/or communications between thermodynamic computing devices may require converting information into a classical computing device form, thus reducing at least some of the benefits of a thermodynamic computer implementation.

### BRIEF DESCRIPTION OF THE DRAWINGS

FIG. 1A is high-level diagram illustrating a process of relay oscillators updating oscillators representing synapse values of an energy-based model, wherein gradient terms are obtained by the relay oscillators, according to some embodiments.

FIG. 1B is high-level diagram illustrating a process of a classical computing device updating oscillators representing synapse values of an energy-based model, wherein gradient terms are obtained by the relay oscillators, according to some embodiments.

FIG. 2A is a high-level diagram illustrating couplings between relay oscillators and oscillators representing neurons of an energy-based model, wherein respective sets of relay oscillators are configured to store gradient terms in a spatial scheme for respective information matrix elements, according to some embodiments.

FIG. 2B is a high-level diagram illustrating couplings between relay oscillators and oscillators representing neurons of an energy-based model, wherein respective sets of relay oscillators are configured to store gradient terms in a temporal scheme for respective information matrix elements, according to some embodiments.

FIG. 2C is a high-level diagram illustrating couplings between relay oscillators and oscillators representing neurons of an energy-based model, wherein respective sets of relay oscillators are configured to store gradient terms in a sequence scheme for respective information matrix elements, according to some embodiments.

FIG. 2D is a high-level diagram illustrating couplings between relay oscillators and oscillators representing neurons of an energy-based model, wherein respective relay oscillators are configured to store gradient terms in a single relay oscillator scheme for respective information matrix elements, according to some embodiments.

FIG. 2E is a high-level diagram illustrating couplings between relay oscillators and oscillators representing neurons of an energy-based model, wherein a set of relay oscillators is configured to relay gradient terms to an array of oscillators representing respective information matrix elements, according to some embodiments.

FIG. 3A is a high-level diagram illustrating couplings between relay oscillators and oscillators representing neurons of an energy-based model, wherein a set of relay oscillators is configured to be measured repeatedly to store components of a synapse parameter update rule on a classical computing device, according to some embodiments.

FIG. 3B is a high-level diagram similar to FIG. 3A, wherein relay oscillators are configured to obtain other components of a parameter update rule, according to some embodiments.

FIG. 3C is a high-level diagram similar to FIG. 3A, wherein relay oscillators are configured to obtain additional components of a parameter update rule, according to some embodiments.

FIG. 3D is a high-level diagram illustrating couplings between relay oscillators and oscillators representing neurons of an energy-based model, wherein a plurality of sets of relay oscillators are configured to be measured to store components of a synapse parameter update rule on a classical computing device, according to some embodiments.

FIG. 4 is a high-level diagram illustrating couplings between relay oscillators, wherein respective relay oscillators represent gradient terms and combination of gradient terms, according to some embodiments.

FIG. 5 is a high-level diagram illustrating oscillators included in a substrate of a thermodynamic chip and a mapping of the oscillators to logical neurons or synapses of the thermodynamic chip, according to some embodiments.

FIG. 6 is an additional high-level diagram illustrating oscillators included in a substrate of the thermodynamic chip mapped to logical neurons, weights, and biases (e.g., synapses) of a neuro-thermodynamic computing system, according to some embodiments.

FIG. 7 illustrates example couplings between visible neurons, weights, and biases (e.g., synapses) of a thermodynamic chip, according to some embodiments.

FIG. 8A illustrates example couplings between visible neurons of a thermodynamic chip, according to some embodiments.

FIG. 8B illustrates example couplings between visible neurons and non-visible neurons (e.g., hidden neurons) of a thermodynamic chip, according to some embodiments.

FIG. 9 is a flowchart illustrating an example process of determining updated synapse values based on determined gradient values, according to some embodiments.

FIG. 10 is a flowchart illustrating an example process of configuring oscillators and relay oscillators of a thermodynamic chip to determine and store gradient terms used to update synapse parameters, according to some embodiments.

FIG. 11A is a flowchart illustrating an example process of determining multiple gradient terms and combining the gradient terms used to update synapse parameters, according to some embodiments.

FIG. 11B is a continuation of a flowchart in FIG. 11A, according to some embodiments.

FIG. 11C is a flowchart illustrating an example process of continuing a flowchart in FIG. 11B, wherein bias and weighting values are updated in a fully analogue way, according to some embodiments.

FIG. 11D is a flowchart illustrating an example process of continuing a flowchart in FIG. 11B, wherein bias and weighting values are updated using a classical computing device, according to some embodiments.

FIG. 12 is a high-level diagram illustrating an example neuro-thermodynamic computer comprising a thermodynamic chip included in a dilution refrigerator and coupled to a classical computing device in an environment external to the dilution refrigerator, according to some embodiments.

FIG. 13 is a high-level diagram illustrating an example neuro-thermodynamic computer comprising a thermodynamic chip included in a dilution refrigerator and coupled to a classical computing device that is also included in the dilution refrigerator, according to some embodiments.

FIG. 14 is a high-level diagram illustrating an example neuro-thermodynamic computer comprising a thermodynamic chip coupled to a classical computing device in an environment other than a dilution refrigerator, according to some embodiments.

FIG. 15 illustrates an example apparatus for measuring positions of oscillators of a thermodynamic chip using a flux read-out device, according to some embodiments.

FIG. 16 is a diagram illustrating hardware components that may be used to implement oscillators of a first and second energy-based models (EBMs), as well as two different example hardware configurations of a relay oscillator that have a time-dependent mass or a time-dependent frequency, respectively, according to some embodiments.

FIG. 17 is a block diagram illustrating an example computer system that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

The present disclosure relates to methods, systems and an apparatus for performing computer operations using a thermodynamic chip. In some embodiments, a thermodynamic chip may comprise oscillators configured to be coupled with one another to represent one or more engineered Hamiltonians. There may be a plurality of configurations of coupling respective ones of the oscillators that correspond to the one or more engineered Hamiltonians. The oscillators of the thermodynamic chip may comprise oscillators (neuron oscillators) representing neurons of a learning model. Furthermore, synapse parameters representing synapse values (e.g., weights and biases) for the neurons may be provided. In some embodiments, synapse parameters may be dynamical degrees of freedom (e.g., oscillators of the thermodynamic chip representing synapse values) and may be updated in a fully analogue way. In some other embodiments, synapse parameters may not be dynamical degrees of freedom (e.g., synapse parameters are not represented by oscillators), wherein synapse parameter values may be configured and updated via software.

In some embodiments, the learning model may be implemented by an energy-based model (EBM) wherein oscillators may evolve according to Langevin dynamics. The energy-based model (EBM) may be trained, wherein oscillators representing synapse values may be adjusted. To assist in determining how to adjust synapse parameters, a set of relay oscillators may be used. For example, one or more relay oscillators may couple to oscillators of the energy-based model (EBM), wherein respective ones of the relay oscillators may be configured to obtain and or store gradient terms of the engineered Hamiltonian. These gradient terms may be used to determine how to adjust synapse parameters of the energy-based model (EBM). For example, a gradient term may indicate how sensitive the learning model is with respect to various factors or parameters. For example, a larger gradient with respect to a given parameter may indicate that the energy based model has a larger response to a change in the given parameter than a change of another given parameter with a smaller gradient with respect to the other given parameter. In some embodiments, gradient terms may be determined in a fully analogue way, wherein measurements of the relay oscillators are not necessary. In some embodiments, a given relay oscillator may obtain a given element of a gradient term. In some embodiments, some elements of a gradient term may be negligible, wherein the negligible element is not stored on a relay oscillator. In some embodiments, thermodynamic information (e.g., information representing elements of a gradient term) may be stored in a position degree of freedom of an oscillator.

In some embodiments, a set of one or more first relay oscillators may be configured to store respective elements of an average gradient term corresponding to a given pair of oscillators representing synapse values. Such a gradient term may be called a synapse pair gradient. To obtain an element of a synapse pair gradient, a coupling may be configured between respective ones of the relay oscillators and respective ones of the oscillators representing neurons (neuron oscillators), wherein the neuron oscillators are coupled to the pair of synapse oscillator of interest. The coupling may be structured according to an engineered potential energy function wherein evolution of the oscillators allows the respective elements of the synapse pair gradient term to be obtained on respective relay oscillators. In some embodiments, a set of one or more second relay oscillators may be configured store respective elements of an average gradient term of a given synapse parameter. Such a gradient term may be called a synapse gradient. To obtain an element of a synapse gradient, a coupling may be configured between respective ones of the relay oscillators and respective ones of the oscillators representing neurons (neuron oscillators), wherein the neuron oscillators may be coupled to the synapse parameter of interest. The coupling may be structured according to an engineered potential energy function wherein evolution of the oscillators allows the respective elements of the synapse gradient term to be obtained on respective relay oscillators. Furthermore, in some embodiments, a third set of one or more third relay oscillators may be configured to compute and store information matrix elements based on gradient terms obtained. Such an information matrix element may be used to determine how to adjust a synapse parameter represented by a synapse oscillator.

In some embodiments, and more generally, a set of one or more relay oscillators may be configured to store respective elements of a gradient term of interest. To obtain an element of the gradient term of interest, a coupling may be configured between respective ones of the relay oscillators and respective ones of the oscillators representing neurons (neuron oscillators) and or respective ones of the oscillators representing synapses. (e.g., synapse oscillators if synapse parameters are represented by oscillators). In some embodiments, synapse parameters may be configured and updated via software, wherein a synapse parameter is not represented by an oscillator. The coupling may be structured according to an engineered potential energy function wherein evolution of the oscillators allows the respective elements of the gradient term of interest to be obtained on respective relay oscillators.

For example, in some embodiments, gradient terms of interest may correspond to terms of a natural gradient descent (NGD) protocol. Natural gradient descent builds from a gradient descent protocol in a way to improve iteration to convergence. For example, gradients of a natural gradient descent (NGD) protocol, along with a determined information matrix, can be used to calculate new weights and bias values that may be used as synapse values in an updated version of the energy-based model. The process of obtaining gradients and determining updated weights and biases may be repeated multiple times until a learning threshold for the energy-based model has been reached. For example, some gradient terms may include positive and negative phase terms to be used to calculate new weights and bias values.

In some embodiments, the synapse oscillator may be updated according to one or more gradient terms and or information matrix elements in a fully analogue way. For example, couplings between respective relay oscillators and respective synapse oscillators may be used to implement a potential energy function, wherein an updated synapse value may be transferred to the synapse oscillators. In some embodiments, a classical computing device may be used to store measured values of relay oscillators wherein synapse parameter update values may be computed based on the measured values. In such an embodiment, a classical computing device determines updated synapse parameters and causes the synapse oscillators to obtain the new updated synapse parameter values.

A neuro-thermodynamic processor may be configured such that learning algorithms for learning parameters of an energy-based model (EBM) may be applied using Langevin dynamics. For example, a first group of oscillators (neuron oscillators) may represent a first set of neurons of the EBM, and a second group oscillators (synapse oscillators) of the EBM may represent synapse values (e.g., weights and biases) for the first set of neurons. A thermodynamic energy-based model (EBM) training gadget may be utilized to train and update the synapse values based on gradient terms obtained by relay oscillators of the thermodynamic EBM training gadget. The oscillators representing the neurons of the EBM may be arranged and configured to represent a Hamiltonian that is engineered to represent a desired function. The synapse oscillators for the neurons may be coupled to respective neuron oscillators, and relay oscillators may be configured to couple to respective other oscillators to obtain, store and relay gradient terms as the relay oscillators evolve naturally according to Langevin dynamics. For example, gradient terms may include how an energy function changes with respect to changes in synapse values and/or pairs of synapse values. Gradient terms may represent parts of an information matrix and other terms that may be used to update synapse values and train the EBM. Training of the EBM may progress until convergence to a desired learning level is achieved. A trained EBM may be used as a function to take on input data and output a result.

More particularly, physical elements of a thermodynamic chip may be used to physically model evolution according to Langevin dynamics. For example, in some embodiments, a thermodynamic chip includes a substrate comprising oscillators implemented using superconducting flux elements. The oscillators may be mapped to neurons (visible or hidden) that “evolve” according to Langevin dynamics. For example, the oscillators of the thermodynamic chip may be initialized in a particular configuration and allowed to thermodynamically evolve. As the oscillators “evolve” degrees of freedom of the oscillators may be sampled. Values of these sampled degrees of freedom may represent, for example, vector values for neurons or synapses that evolve according to Langevin dynamics. For example, algorithms that use stochastic gradient optimization and require sampling during training, such as those proposed by Welling and Teh, and/or other algorithms, such as natural gradient descent, mirror descent, etc. may be implemented using a thermodynamic chip. In some embodiments, a thermodynamic chip may enable such algorithms to be implemented directly by sampling the neurons and/or synapses (e.g., degrees of freedom of the oscillators of the substrate of the thermodynamic chip) without having to calculate statistics to determine probabilities. As another example, thermodynamic chips may be used to perform autocomplete tasks, such as those that use Hopfield networks, which may be implemented using natural gradient descent. For example, visible neurons may be arranged in a fully connected graph (such as a Hopfield network, etc.), and the values of the auto complete task may be learned using a natural gradient descent algorithm.

In some embodiments, a thermodynamic chip includes superconducting flux elements arranged in a substrate, wherein the thermodynamic chip is configured to modify magnetic fields that couple respective ones of the oscillators with other ones of the oscillators. In some embodiments, non-linear (e.g., anharmonic) oscillators are used that have dual-well potentials. These dual-well oscillators may be mapped to neurons of a given energy-based model that the thermodynamic chip is being used to implement. Also, in some embodiments, at least some of the oscillators may be harmonic oscillators with single-well potentials. In some embodiments, oscillators may be implemented using superconducting flux elements with varying amounts of non-linearity. In some embodiments, an oscillator may have a single well potential, a dual-well potential, or a potential somewhere in a range between a single-well potential and a dual-well potential. In some embodiments, an oscillator may have a generic potential other than a single or double-well potential. In some embodiments, visible neurons may be mapped to oscillators having a single well potential, a dual-well potential, or a potential somewhere in a range between a single-well potential and a dual-well potential.

In some embodiments, oscillators of the thermodynamic chip may also be used to represent values of weights and biases of the energy-based model. Thus, weights and biases that describe relationships between neurons may also be represented as dynamical degrees of freedom, e.g., using oscillators of the thermodynamic chip (e.g., synapse oscillators).

In some embodiments, parameters of an energy-based model or other learning algorithm may be learned through evolution of the oscillators of a thermodynamic chip.

In some embodiments, gradient terms may be combined to obtain other gradient terms or a full parameter update rule. For example, elements of an information matrix may be represented by the combination of synapse gradients and synapse pair gradients. Elements of an information matrix may be combined with gradients representing positive and negative phase terms to obtain an overall synapse value update. These gradient terms and combinations may be obtained by implementing relay oscillators to have an engineered potential, wherein dynamically evolving according to Langevin dynamics with the configured potential allows desired relay oscillators to obtain desired thermodynamic values (e.g., gradient terms or combinations of gradient terms). To train the EBM, relay oscillators may then be coupled to synapse oscillators in a way that updates the synapse oscillators to a new synapse value. In some embodiments, to train the EBM, relay oscillators representing gradient terms may be measured and the gradient term may be stored to a classical computing device, wherein the classical computing device causes the synapse oscillators to take on updated values. Nevertheless, in some embodiments, updating synapse values may be accomplished in a completely analogue way, wherein no measurements are necessary. This may allow for benefits such as increased training speed, or reduction in energy consumption as compared to classically training a model such as a neural network.

Relay oscillators may provide a powerful tool for capturing mean field dynamics of neurons which may represent visible and latent variables of energy-based models (EBMs). In some embodiments, three protocols may be used for relay oscillators such that their position degrees of freedom may reach thermal equilibrium at the expectation value of an output oscillator part of some EBM. Note that both the values of the neurons and the values of the synapses may be encoded using position degrees of freedom of respective oscillators.

In some embodiments, relay oscillator protocols may be used to capture expectation values needed for training parameters of an energy-based models using natural gradient descent (NGD). For example, two protocols may be used (e.g. a fully analogue protocol and a hybrid protocol involving both thermodynamic evolution and use of a classical computing device to update synapse values). For example, in the fully analogue protocol the learnable parameters are dynamical degrees of freedom. Such parameters may be coupled to a subset of the relay oscillators which encode the correct NGD update rule. Alternatively, measurements may be performed of such relay oscillators and the parameters may be updated on a classical post-processing device. Such a setting does not require the parameters to be dynamical degrees of freedom.

In some embodiments, and as a general overview of this disclosure, examples of a spatial relay oscillator protocol and a temporal relay oscillator protocol are provided. In either protocol, Bogoliubov-Kubo-Mori (BKM) matrix elements need to be determined, where the BKM matrix elements are needed for performing parameter updates using a natural gradient descent protocol (NGD). In the spatial scheme for performing the NGD protocol, blocks of relay oscillators are used to store intermediate values (e.g. the values are stored spatially) when determining the BKM matrix elements. For example, the spatial scheme may be used to obtain all components of the Bogoliubov-Kubo-Mori (BKM) matrix elements in parallel. A temporal scheme for performing the NGD protocol is also described. In the temporal scheme, a single block of relay oscillators may be repeatedly re-used to determine intermediate values, wherein the relay oscillators are measured, and the intermediate values are stored to a classical computing device prior to the re-use of the relay oscillator with regard to determining a next intermediate value. In the temporal protocol, all components of the BKM matrix elements are obtained sequentially (and intermediate values are stored as the sequence of operations are performed). Also, in addition to determining the elements of the BKM matrix, positive and negative phase terms are needed when performing the NGD protocol. Additional relay oscillators used for computing the positive and negative phase terms of the NGD update rule in a fully analogue fashion are described. A final set of relay oscillators are introduced which are coupled to the previously defined relay oscillators through a Gaussian potential, and whose equilibrium statistics results in the desired NGD update rule. Oscillators which encode the parameter degrees of freedom (for a given parameter used in the NGD protocol) can be coupled to the final set of relay oscillators to evolve according to the NGD update rule. Alternatively, in the temporal protocol, a measurement-based scheme may be utilized, wherein relevant parameters are measured and stored to a classical computing device (as opposed to being maintained in a relay oscillator). Also, at least some computations may be performed on the classical computing device.

In some embodiments, a space averaged relay oscillator protocol may be used. Such a relay oscillator protocol may be used to store the components of the relevant metric for performing natural gradient descent (NGD).

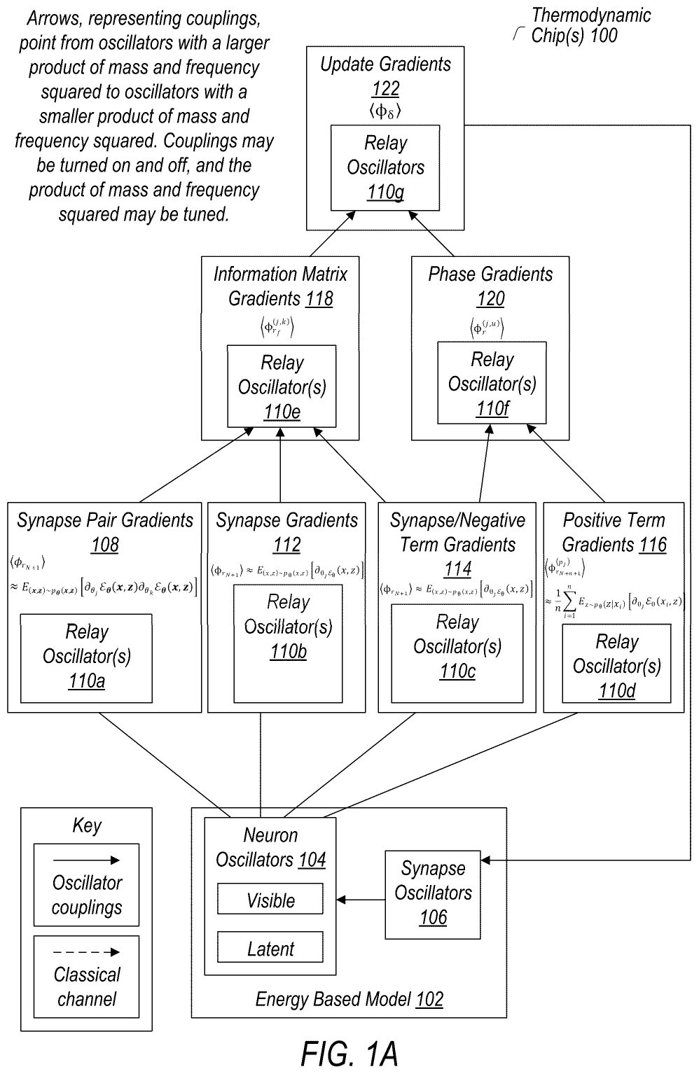

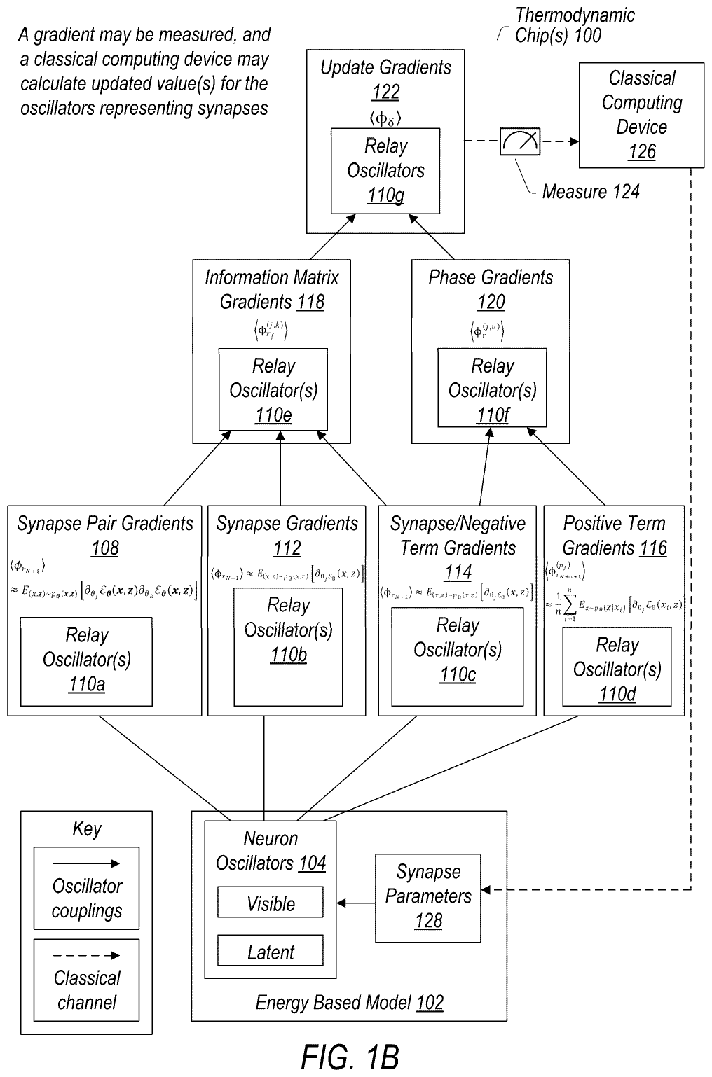

FIG. 1A is a high-level diagram illustrating a process of relay oscillators updating oscillators representing synapse values of an energy-based model, wherein gradient terms are obtained by the relay oscillators, according to some embodiments.

In some embodiments, synapse parameters may be dynamical degrees of freedom represented by synapse oscillators, wherein the synapse parameters may be updated un a fully analogue way. For example, energy-based model 102 may comprise oscillators representing neurons (e.g., neuron oscillators 104) and oscillators representing synapses (e.g., synapse oscillators 106) for a learning model. Neuron oscillators 104 may comprise oscillators representing visible and latent (e.g., hidden) neurons of the energy-based model (EBM) 102. Visible neurons may couple to input or output values, and latent neurons may be intermediate neurons between visible neurons. In some embodiments, neuron oscillators 104 may be coupled to synapse oscillators 106. In some embodiments, oscillators comprise respective products of mass and frequency squared corresponding to physical hardware components and configuration of the oscillator. In some embodiments, the product of mass and frequency squared of synapse oscillators may be larger than the product of mass and frequency squared of a neuron oscillator coupled to the synapse oscillator, wherein the synapse oscillator may be treated as static. Energy-based models (EBMs) may be combined with other EBMs to form a sequence of EBMs. Respective EBMs may undergo a similar training procedure as described herein to train part or all of sequence of EBMs.

In some embodiments, neuron oscillators 104 and or synapse oscillators 106 may be coupled to one or more relay oscillators (e.g., such as relay oscillators 110a-d representing gradient terms such as gradient terms 108, 112, 114, 116). For example, neuron oscillators 104 may be coupled to relay oscillator(s) 110a wherein relay oscillator(s) 110a are configured to obtain and store synapse pair gradients terms 108. Thermodynamic information is relayed from the neuron oscillators 104 to one or more of the relay oscillators 110a. Coupling of oscillators and or relay oscillators via an engineered potential energy function may enable the relaying of the thermodynamic information. There may be several relay oscillator protocols and configurations implemented to obtain and store gradient terms. For example, a spatial analogue relay oscillator protocol may take simultaneous samples. In other embodiments, a temporal analogue relay oscillator protocol may obtain and store gradient terms one after another. In yet other embodiments, a sequence analogue relay oscillator protocol may comprise a chain of relay oscillators that continuously take samples of respective oscillators of interest. In such embodiments, an additional relay oscillator takes on the expectation value corresponding to a desired gradient term. The desired gradient terms are at least used in part to obtain an updated synapse parameter (e.g., train the model). Such gradient terms may include, synapse pair gradients 108 (e.g., such as shown in equation 14, [symbol] ϕᵣ_{_{N+1}} [symbol] ≈E_{(x,z)˜p}_{_{θ}}_{(x,z)} [∂_{θ}_{ⱼ}ε_{θ}(x,z)∂_{θ}_{ₖ}ε_{θ}(x, z)])), synapse gradients 112 (e.g., such as shown in equation 16, [symbol] ϕᵣ_{_{N+1}} [symbol] ≈E_{(x,z)˜p}_{_{θ}}_{(x,z)} [∂_{θ}_{ⱼ}ε_{θ}(x, z)]), synapse/negative phase term gradients 114 (e.g., such as shown in equation 16), and positive phase term gradients 116 (e.g., such as shown in equation 20,

$${ϕ}_{{r}_{N + n + 1}}^{( {p}_{j} )} \approx \frac{1}{n} {\sum }_{i = 1}^{n} {E}_{z ∼ p θ ( Z \vert {X}_{i} )} [ {\partial }_{{θ}_{j}} {ℰ}_{θ} ( {x}_{i} , z ) ] ) .$$

Other gradient terms may be obtained by coupling relay oscillators to neuron oscillators 104 and or synapse oscillators 106.

In some embodiments, one or more gradient term such as synapse pair gradient 108, synapse gradient 112, synapse/negative phase term gradient 114, or positive phase term gradient 116 may couple to other relay oscillators such as 110e or 110f to obtain combination of gradient terms such as information matrix gradients 118 or phase term gradients 120. In some embodiments, one or more relay oscillators of relay oscillators 110e may obtain and store information matrix gradient terms, e.g., such as shown in equation 18

$${ϕ}_{{r}_{f}}^{( j , k )} = \frac{2 {λ}_{3}}{2 {λ}_{3} + {m}_{f} {ω}_{f}^{2}} ( {E}_{( x , z ) ∼ {p}_{θ} ( x , z )} [ {\partial }_{{θ}_{j}} {ℰ}_{θ} ( x , z ) {\partial }_{{θ}_{k}} {ℰ}_{θ} ( x , z ) ] - {E}_{( x , z ) ∼ {p}_{θ} ( x , z )} [ {\partial }_{{θ}_{j}} {ℰ}_{θ} ( x , z ) ] {E}_{( x , z ) ∼ {p}_{θ} ( x , z )} [ {\partial }_{{θ}_{k} {ℰ}_{θ}} ( x , z ) ] ) .$$

In some embodiments, one or more relay oscillators of relay oscillators 110f may obtain and store phase gradient terms, e.g., such as shown in equation 24,

$${ϕ}_{r}^{( j , u )} \approx - \frac{2 {λ}^{( 2 , u )}}{2 {λ}^{( 2 , u )} + {{m}_{r}^{( j , u )} ( {ω}_{r}^{( j , u )} )}^{2}} ( \frac{1}{n} {\sum }_{i = 1}^{n} {E}_{z ∼ {p}_{θ} ( Z \vert {X}_{i} )} [ {\partial }_{{θ}_{j}} {ℰ}_{θ} ( {x}_{i} , z ) ] - {E}_{( x , z ) ∼ {p}_{θ} ( x , z )} [ {\partial }_{{θ}_{j}} {ℰ}_{θ} ( x , z ) ] ) .$$

Coupling of relay oscillators via an engineered potential energy function may enable the relaying and or processing of thermodynamic information. The coupling may allow for a combined gradient term to be obtained by one or more of the gradient terms stored in relay oscillators 110a-110d. There may be several relay oscillator protocols and configurations implemented to obtain and store combined gradient terms such as described above.

In some embodiments, an update gradient term may be obtained such as update gradients 122. Update gradient terms 112 may include thermodynamic information on how to adjust or update synapse oscillators to train an energy based model (EBM), wherein the information is stored in physical properties of one or more relay oscillators such as relay oscillators 110g. A potential energy function may be initiated that includes relay oscillators such as relay oscillators 110g, 110e, and or 110f. The potential energy function may be engineered such that a desired update gradient such as 122 is obtained. For example, one or more relay oscillators of relay oscillators 110g may obtain update gradient terms representing a full parameter update rule, e.g., such as shown by equation 31,

$${ϕ}_{δ} \approx - \frac{1}{2} {B}_{{r}_{f}}^{- 1} {ϕ}_{r}^{( u )} ,$$

where [symbol] ϕ_{δ} [symbol] is treated as a Gaussian distribution like in equation 27,

$${ϕ}_{δ} = \frac{\int d {ϕ}_{δ} {ϕ}_{δ} {e}^{- β {V}_{δ}}}{\int d {ϕ}_{δ} {e}^{- β {V}_{δ}}} .$$

The relay oscillators ϕ_{δ} 110g may be used to update synapse oscillators 106 in a fully analogue way.

In some embodiments, oscillators of an EBM and relay oscillators may be configured on one or more thermodynamic chip(s) 100. In some embodiments, EBM 102, synapse pair gradients 108, synapse gradients 112, synapse/negative phase term gradients 114, positive phase term gradients 116, information matrix gradients 118, phase gradients 120, and updated gradients for the synapse parameters 122 may be implemented on a single thermodynamic chip. In other embodiments, respective gradient terms may be implemented on respective thermodynamic chips, wherein one thermodynamic chip comprises one or more gradient terms.

In some embodiments, update gradients 122 stored on one or more relay oscillators of relay oscillators 110g may be used to update synapse values by coupling the one or more relay oscillators of 110g to synapse oscillators 106. A potential energy function may be utilized to relay and or process thermodynamic information to update synapse oscillators 106. In such an embodiment, synapse oscillators 106 are updated in a fully analogue way (e.g., no measurements of position degrees of freedom of an oscillator are necessary). For example, a potential energy function, e.g., such as the potential in equation 33 may be implemented. Consequently, the expectation value of the synapse parameters may be represented by an updated synapse value (e.g., parameter update). For example, the updated synapse value may be represented by equation 34,

$${ϕ}_{θ} = \frac{\int d {ϕ}_{θ} d {ϕ}_{δ} {ϕ}_{θ} {e}^{- β {V}_{param} ( θ , δ )}}{\int d {ϕ}_{θ} d {ϕ}_{δ} {e}^{- β {V}_{param} ( θ , δ )}} \approx {θ}_{0} - η {B}_{{r}_{f}}^{- 1} {ϕ}_{r}^{( u )} .$$

FIG. 1B is a high-level diagram illustrating a process of a classical computing device updating oscillators representing synapse values of an energy-based model, wherein gradient terms are obtained by the relay oscillators, according to some embodiments.

In some embodiments, synapse parameters may be updated using a classical computing device. For example, relay oscillators 110g representing update gradients 122 (e.g., a full parameter update rule) may be measured, wherein one or more position degree of freedom of the relay oscillators storing the update gradients 112 are measured. The measured value may be saved to a classical computing device 126, wherein the classical device 126 may calculate how to update the values of synapse parameters 128 to train an EBM. For example, the values of the synapse parameters may be treated as constants and may be updated by the classical computing device 126. Classical computing device 126 may send a signal to synapse parameters, wherein a physical parameter of the oscillator is changed and corresponds to an updated synapse value.

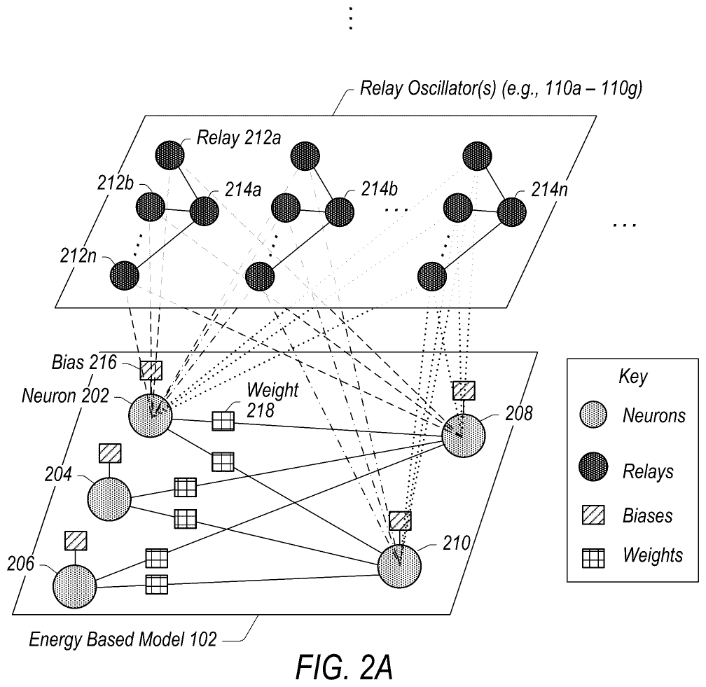

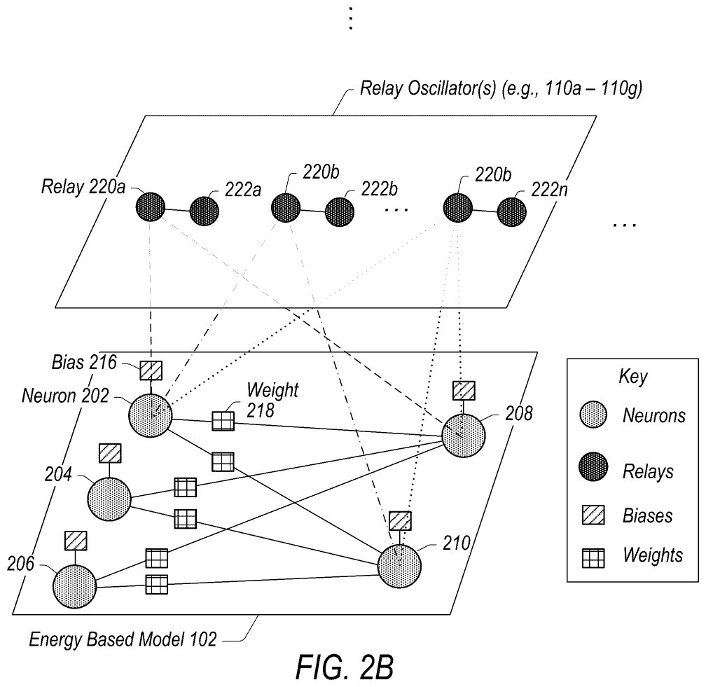

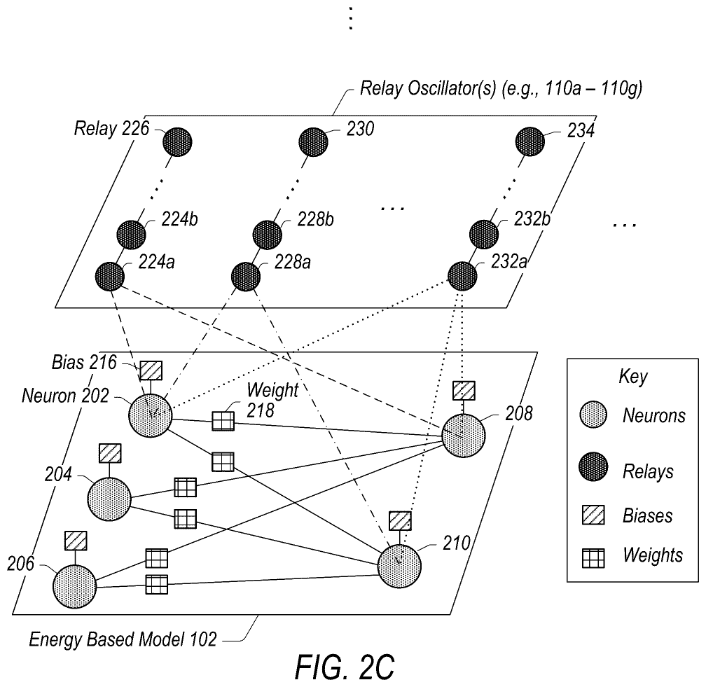

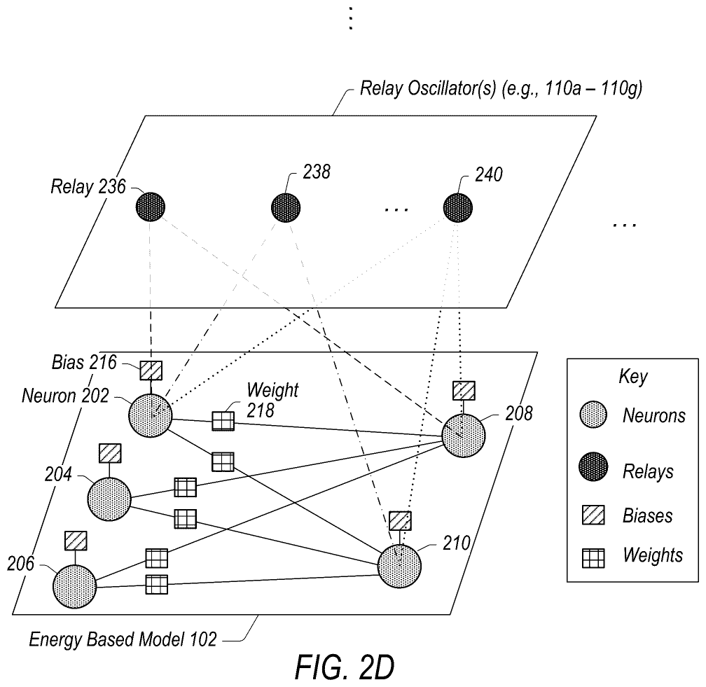

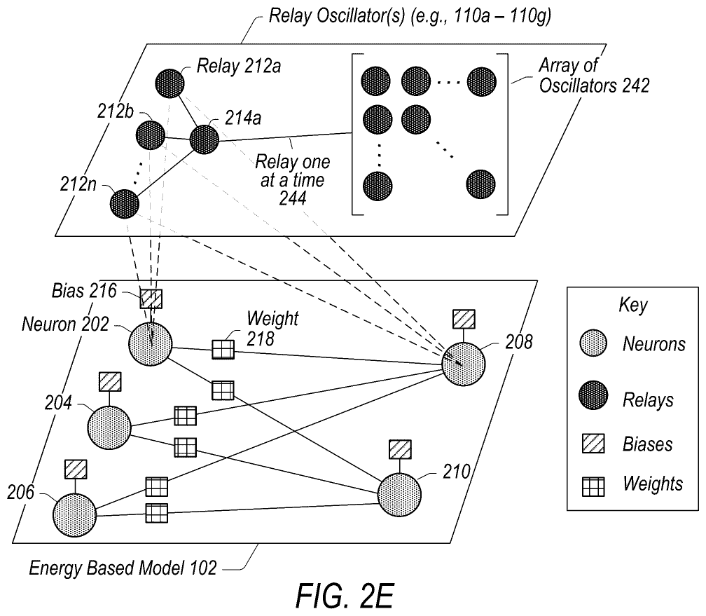

FIG. 2A is a high-level diagram illustrating couplings between relay oscillators and oscillators representing neurons of an energy-based model, wherein respective sets of relay oscillators are configured to store gradient terms in a spatial scheme for respective information matrix elements, according to some embodiments.

In some embodiments, relay oscillators may couple to oscillators representing neurons and or synapse parameters, wherein one or more relay oscillators (of relay oscillators 110a-d) obtain a gradient term (e.g., gradient terms 108, 112, 114, 116). In some embodiments, sets of relay oscillators may be configured to obtain respective elements of an information matrix or positive phase or negative phase terms respective to respective synapse parameters. The gradient terms may be used to update synapse parameter values.

In some embodiments, energy-based model (EBM) 102 may comprise neuron oscillators 202, 204, 206, 208 and 210. Respective neuron oscillators are coupled to synapse oscillators representing bias values of a learning model such as bias oscillator 216. Furthermore, input neurons (e.g., neurons 202, 204, 206) may be coupled to output neurons (e.g., 208, 210) by way of synapse parameters that represent weightings (e.g., 218). The coupling may be such that each input neuron is coupled to each output neuron or any other number of output neurons. Furthermore, EBM 102 may comprise neuron oscillators and synapse oscillators that are configured to implement a potential energy function. Tuning synapse values of the EBM may tune the output of the EBM given a set of input values for the input oscillators. Training the EBM may comprise of iteratively calculating gradient terms and updating synapse values based on the gradient terms.

In some embodiments, a spatial analogue relay protocol is used. For example, relay oscillator 212a couples to neuron oscillator 202 and 208. Furthermore, relay oscillator 212b-n respectively couple to neuron oscillators 202 and 208. Relay oscillators 212a-n relay information to relay oscillator 214a in such a way that an expectation value of a position degree of freedom of relay oscillator 214a corresponds to an element of a gradient term of interest. Furthermore, a plurality of oscillators such as 214a-n may correspond to respective elements of the gradient term of interest, wherein the gradient term of interest may be fully represented. For example, relay oscillator 214b represents another element of a same gradient term of interest, and furthermore, relay oscillator 214n represents yet another element of a same gradient term of interest. In this manner, all elements necessary to represent the gradient term of interest are obtained and stored onto one or more relay oscillators. In some embodiments, some elements of the gradient term of interest are set to zero, and some elements of the gradient term are duplicates of other elements. As such, each and every element of the gradient term of interest may not need to be represented or obtained by a relay oscillator.

FIG. 2B is a high-level diagram illustrating couplings between relay oscillators and oscillators representing neurons of an energy-based model, wherein respective sets of relay oscillators are configured to store gradient terms in a temporal scheme for respective information matrix elements, according to some embodiments.

In some embodiments, a temporal analogue relay protocol is utilized. For example, relay oscillator 220a may be coupled to neuron oscillators 202 and 208, wherein repetitive samples values are obtained that allows an element of a gradient term of interest to be stored on relay oscillator 222a. Furthermore, relay oscillator 220b is coupled to neuron oscillator 202 and 210, wherein relay oscillator 222b corresponds to another element of the gradient term of interest. Generally, a number n of relay oscillators may store n elements of the gradient term of interest.

FIG. 2C is a high-level diagram illustrating couplings between relay oscillators and oscillators representing neurons of an energy-based model, wherein respective sets of relay oscillators are configured to store gradient terms in a sequence scheme for respective information matrix elements, according to some embodiments.

In some embodiments, a sequence analogue relay protocol may be implemented. For example, relay oscillator 224a continually samples thermodynamic values according to a potential energy function governing the dynamics of the system. In a sequence, the relay oscillator 224a transfers thermodynamic information to 224b and so on until relay oscillator 226. The potential energy function is chosen in such a way that the expectation value of relay oscillator 226 corresponds to an element of a gradient term of interest.

FIG. 2D is a high-level diagram illustrating couplings between relay oscillators and oscillators representing neurons of an energy-based model, wherein respective relay oscillators are configured to store gradient terms in a single relay oscillator scheme for respective information matrix elements, according to some embodiments.

FIG. 2E is a high-level diagram illustrating couplings between relay oscillators and oscillators representing neurons of an energy-based model, wherein a set of relay oscillators is configured to relay gradient terms to an array of oscillators representing respective information matrix elements, according to some embodiments.

In some embodiments, a set of relay oscillators such as relay oscillators 212a-212n and 214a may be used to relay a value corresponding to elements of a gradient term of interest to respective relay oscillators in an array of oscillators 242. The set of relay oscillators may be used to obtain respective elements of a gradient term of interest and store the elements on respective relay oscillators of the array of oscillators 242, wherein the elements are stored one at a time 244.

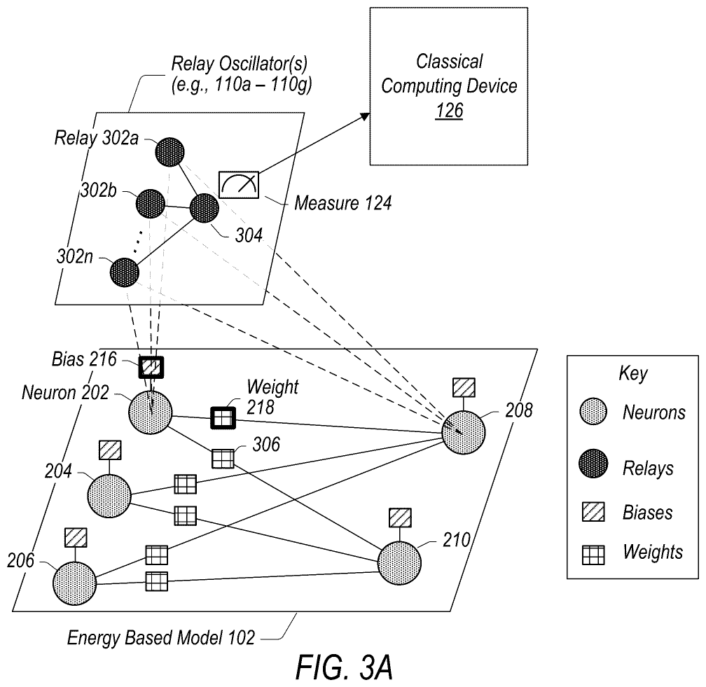

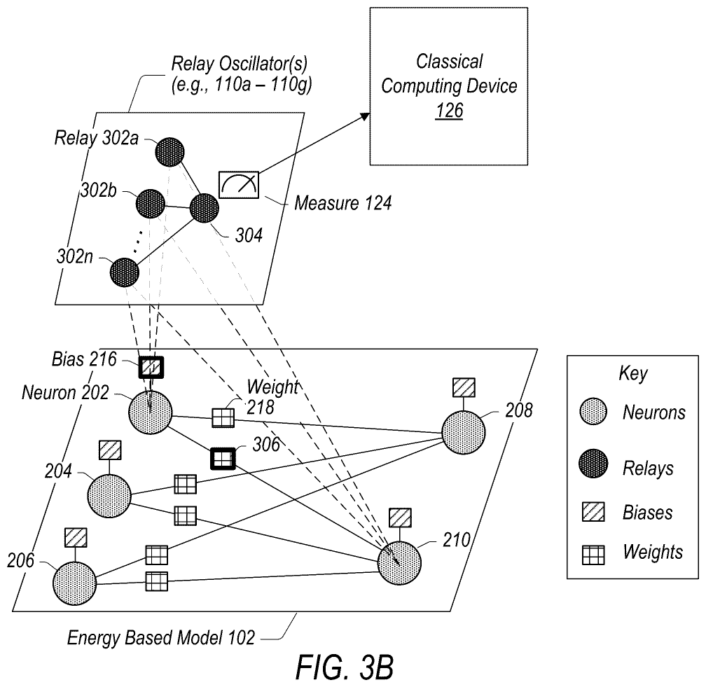

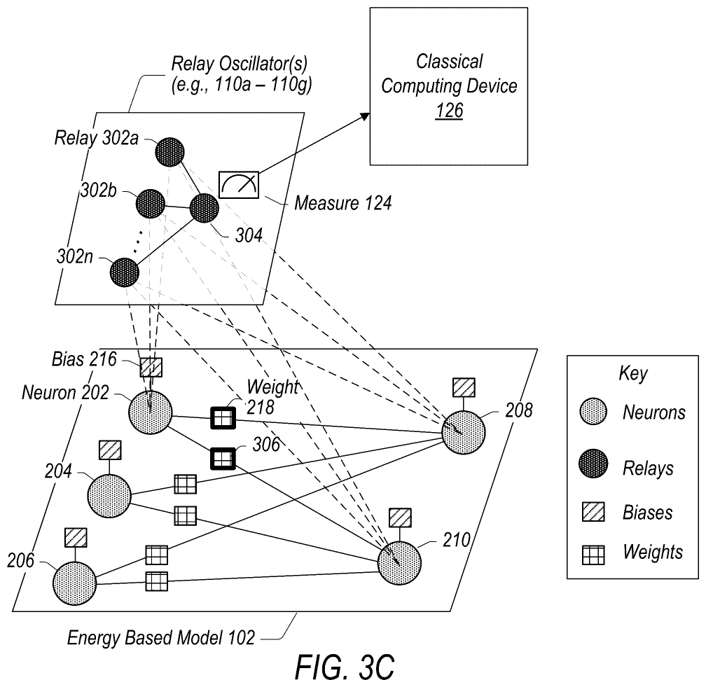

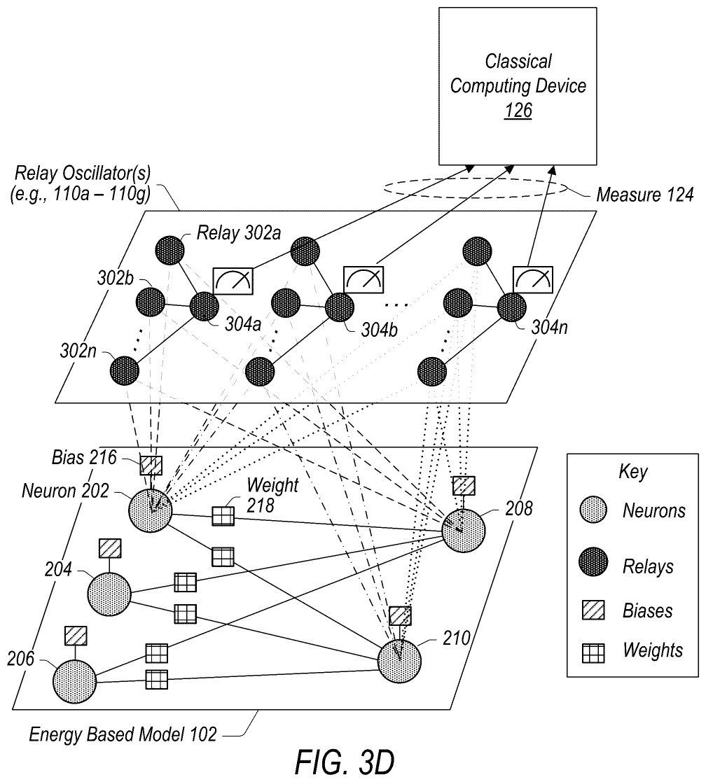

FIG. 3A is a high-level diagram illustrating couplings between relay oscillators and oscillators representing neurons of an energy-based model, wherein a set of relay oscillators is configured to be measured repeatedly to store components of a synapse parameter update rule on a classical computing device, according to some embodiments.

In some embodiments, synapse parameters 128 are not dynamical degrees of freedom, and synapse parameter values may be updated on a classical computing device. In some embodiments, a set of relay oscillators such as relay oscillators 302a-n and 304 may be used to obtain elements of a gradient term of interest and/or elements of a full update rule for synapse parameters. For example, relay oscillators 302a-n are coupled to neurons 202 and 208 in such a way that a gradient term of interest with respect to the synapse parameters of bias 216 and 218 is obtained. Furthermore, relay oscillators 302a-n relay thermodynamic information to relay oscillator 304 such that the expectation value of relay oscillator 304 corresponds to an element of a full parameter update rule, wherein relay oscillator 304 may be measured 124 and the measurement result may be stored on a classical computing device 126. The protocol used to relay thermodynamic information is not limited to a spatial analogue relay protocol. Any suitable protocol may be used, wherein elements of a gradient term of interest correspond to an expectation value of a relay oscillator configured to be measured (e.g., relay oscillator 304).

In some embodiments, synapse parameters 128 are not dynamical degrees of freedom, and synapse parameter values may be updated on a classical computing device. In some embodiments, and more specifically, a full parameter update rule may be obtained by relay oscillator ϕ_{δ} 304. The relay oscillator ϕ_{δ} 304 may then be measured 124, wherein classical computing device 126 may update the synapse parameters 128 based on the full parameter update rule. In such an embodiment, only the relay oscillator that obtained the full parameter update rule (e.g., relay oscillator ϕ_{δ} 304) needs to be measured, and relay oscillators corresponding to other gradient terms do not need to be measured. Thus, measurements may only need to be taken at the end of the protocol. The time to take measurements may be long, so reducing the number of measurements needed may speed up the training process.

For example, the average position degree of freedom of relay oscillator 304 (e.g., ϕ_{δ}) may correspond to information related to a full parameter update rule such as shown in equation 31 (e.g., the second term on the right-hand side of equation 12). Thus, when the position degree of freedom of relay oscillator 304 is measured, information relating to the full update term may be obtained. Thus, synapse parameters may be updated on a classical computing device (e.g., see equation 37).

FIG. 3B is a high-level diagram similar to FIG. 3A, wherein relay oscillators are configured to obtain other elements of a parameter update rule, according to some embodiments.

In some embodiments, a same set of relay oscillators may be used to obtain another element of a parameter update rule of interest (e.g., corresponding to synapse parameters of bias 216 and weight 306), wherein synapse parameters are not dynamical degrees of freedom (e.g., synapse parameters are not represented by oscillators).

FIG. 3C is a high-level diagram similar to FIG. 3A, wherein relay oscillators are configured to obtain additional elements of a parameter update rule, according to some embodiments.

In some embodiments, a same set of relay oscillators may be used to obtain yet another element of a gradient term of interest (e.g., corresponding to synapse parameters of wight 218 and weight 306).

FIG. 3D is a high-level diagram illustrating couplings between relay oscillators and oscillators representing neurons of an energy-based model, wherein a plurality of sets of relay oscillators are configured to be measured to store components of a synapse parameter update rule on a classical computing device, according to some embodiments.

In some embodiments, a plurality of oscillators may be used to obtain elements of a parameter update rule. For example, a full parameter update rule may correspond to the expectation value of oscillators 304a-n (e.g., respective ϕ_{δ} oscillators, see equation 31). Oscillators 304a-n may be measured 124 in parallel, wherein the measurement result may be stored on a classical computing device. Synapse parameter values may be updated according to the full parameter update rule obtained at least in part from the oscillators 304a-n.

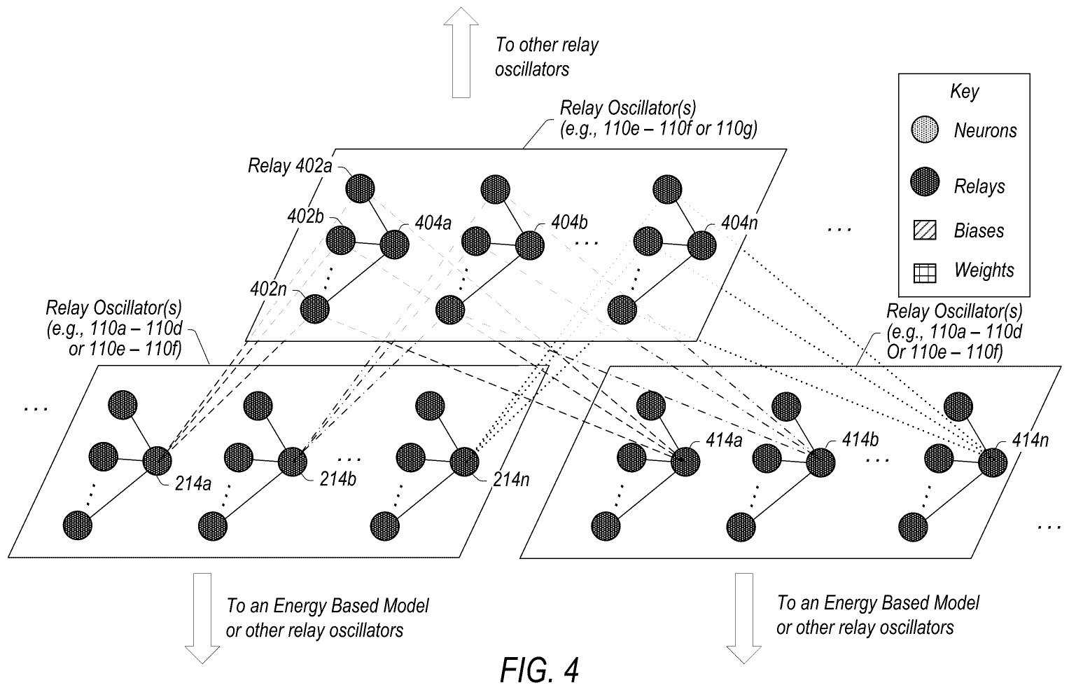

FIG. 4 is a high-level diagram illustrating couplings between relay oscillators, wherein respective relay oscillators represent gradient terms and combination of gradient terms, according to some embodiments.

In some embodiments, a given relay oscillator 214a corresponding to an element of a gradient term of interest (e.g., an element of synapse gradient term 112), and another given relay oscillator 414a corresponding to an element of another gradient term of interest (e.g., an element of another synapse gradient term 114) may be included in a potential that enables a combined gradient term (e.g., part of an element of an information matrix gradient term 118) to be obtained and stored on a relay oscillator (e.g., relay oscillator 404a). For example, respective elements of a first gradient term may be combined with corresponding elements of a second gradient term to obtain a corresponding element of a combined gradient term. In some embodiments, thermodynamic information is relayed in a fully analogue way, wherein measurements are not necessary.

In some embodiments, a given relay oscillator 214a corresponding to an element of a combined gradient term of interest (e.g., an element of information matrix 118), and another given relay oscillator 414a corresponding to an element of another combined gradient term of interest (e.g., an element of a phase gradient term 120) may be included in a potential that enables a combination of combined gradient term (e.g., part of an element of update gradient term 122) to be obtained and stored on a relay oscillator (e.g., relay oscillator 404a). For example, respective elements of a first combined gradient term may be combined with corresponding elements of a second combined gradient term to obtain a corresponding element of a combination of combinations of gradient terms. In some embodiments, thermodynamic information is relayed in a fully analogue way, wherein measurements are not necessary.

In some embodiments, a combination of combinations of at least two average gradients stored on respective relay oscillators may be used to update corresponding synapse parameter values. A potential function may be established that allows relay oscillators corresponding to the combination of combinations of average gradients to update synapse parameters (e.g., 106) of an energy-based model (EBM) (e.g., 102). In some embodiments, a combination of at least two average gradients stored on respective relay oscillators may be used to update corresponding synapse parameter values. A potential function may be established that allows relay oscillators corresponding to the combination of average gradients to update synapse parameters (e.g., 106) of an energy-based model (EBM) (e.g., 102). In some embodiments, average gradient terms stored on respective relay oscillators may be used to update corresponding synapse parameter values. A potential function may be established that allows relay oscillators corresponding to the of average gradients to update synapse parameters (e.g., 106) of an energy-based model (EBM) (e.g., 102).

A more detailed description is given below, suppose an EBM has an output oscillator whose position degree of freedom is ϕ_{y}. In such an example, it may be desirable to transfer the expectation value [symbol] ϕ_{y} [symbol] of the output oscillator of the EBM to the state of another oscillator, e.g. a relay oscillator, and effectively make the relay oscillator static at the expectation value. The relay oscillator can then be used as input to another EBM block, where the input will be approximately [symbol] ϕ_{y} [symbol] . The output oscillator ϕ_{y} may have an arbitrary potential, and can be coupled to multiple other oscillators of the EBM, such as oscillators in the input-side of the EBM block. In what follows, a space averaged protocol may be used which uses intermediate relay oscillators {ϕᵣ_{₁}, ϕᵣ_{₂}, . . . , ϕᵣ_{_{N}}} and a final output relay oscillator ϕᵣ_{_{N+1}}. Note that temporal and sequenced based relay oscillator protocols are also possible which may use fewer relay oscillators.

For example, consider the Hamiltonian for the coupling between the output oscillator ϕ_{y} of the input EBM module, the intermediate relay oscillators {ϕᵣ_{₁}, ϕᵣ_{₂}, . . . , ϕᵣ_{_{N}}} and the output relay oscillator ϕᵣ_{_{N+1}}. In some embodiments, optional bias oscillators may also be include which are coupled to the relay oscillators. The Hamiltonian is given by,

$$H = \frac{{π}_{y}^{2}}{2 {m}_{y}} + {\sum }_{j = 1}^{N} \frac{{π}_{{r}_{j}}^{2}}{2 {m}_{r} ( t )} + \frac{{π}_{{r}_{N + 1}}^{2}}{2 {\tilde{m}}_{r} ( t )} + {\sum }_{j = 1}^{N} \frac{{π}_{{b}_{j}}^{2}}{2 {m}_{b}} + \frac{{π}_{{r}_{{b}_{N + 1}}}^{2}}{2 {\tilde{m}}_{b}} + {{λ}_{y} ( 1 - {ω}_{y} {ϕ}_{y}^{2} )}^{2} + \frac{1}{2} {m}_{r} ( t ) {{ω}_{r} ( t )}^{2} {\sum }_{j = 1}^{N} {ϕ}_{{r}_{j}}^{2} + \frac{1}{2} {\tilde{m}}_{r} ( t ) {{\tilde{ω}}_{r} ( t )}^{2} {ϕ}_{{r}_{N + 1}}^{2} + \frac{1}{2} {m}_{b} {ω}_{b}^{2} {\sum }_{j = 1}^{N} {ϕ}_{{b}_{j}}^{2} + \frac{1}{2} {\tilde{m}}_{b} {\tilde{ω}}_{b}^{2} {ϕ}_{{b}_{N + 1}}^{2} + {\sum }_{j = 1}^{N} {λ}_{{r}_{j}} ( t ) {( {ϕ}_{{r}_{j}} - {ϕ}_{y} )}^{2} + {λ}_{{r}_{N + 1}} ( t ) {\sum }_{j = 1}^{N} {( {ϕ}_{{r}_{N + 1}} - {ϕ}_{{r}_{j}} )}^{2} + {\sum }_{j = 1}^{N} {λ}_{{b}_{j}} ( t ) {ϕ}_{{b}_{j}} {ϕ}_{{r}_{j}} + {λ}_{{b}_{N + 1}} ( t ) {ϕ}_{{b}_{N + 1}} {ϕ}_{{r}_{N + 1}} ,$$

(equation 1), where it may be assumed that either the mass or frequencies of the relay oscillators can be time-dependent. Without loss of generality, the term

$${{λ}_{y} ( 1 - {ω}_{y} {ϕ}_{y}^{2} )}^{2}$$

in equation 1 is used to indicate a double well potential. Other types of potentials may be used, such as a multi-well potential or a tilted well and so on. Couplings between $ y and other oscillators in the input module may be ignored since it does not affect the results in what follows below.

In some embodiments, given the Hamiltonian in equation 1, the equilibrium value is such that [symbol] ϕ_{r_{N+1}} [symbol] ≈ [symbol] ϕ_y [symbol] . This may be shown in three parts. For example, start by setting the product

$${m}_{r} {ω}_{r}^{2} << {m}_{y} {ω}_{y}^{2}$$

for all the intermediate relay oscillators {ϕᵣ_{₁}, ϕᵣ_{₂}, . . . , ϕᵣ_{_{N}}}. The coupling parameters {λᵣ_{₁}(t), λᵣ_{₂}(t), . . . , λᵣ_{_{N}}(t)} are then turned on simultaneously. However, in order to get diverse samples encoded in the position degrees of freedom of the oscillators {ϕᵣ_{₁}, ϕᵣ_{₂}, . . . ϕᵣ_{_{N}}}, the coupling parameters are turned off at different time intervals. In particular, write the j^{th} time-dependent coupling parameter (for 1≤j≤N)λᵣ_{ⱼ}(t) as,

$${λ}_{{r}_{j}} ( t ) = {λ}_{r} ( σ ( {k}_{r} ( t - {t}_{r} ) ) - σ ( {k}_{r} ( t - {t}_{{r}_{j}} ) ) ) ,$$

(equation 2), where σ(x) is the sigmoid function. Note that other functions, such as tanh and many others, may be used. The parameter kᵣ determines how quickly λᵣ_{ⱼ}(t) is turned on and off, and λᵣ determines the maximum strength of the coupling parameter. The same kᵣ and λᵣ parameters may be used for respective time-dependent coupling parameters {λᵣ_{₁}(t), λᵣ_{₂}(t), . . . , λᵣ_{_{N}}(t)}. The parameter tᵣ determines when λᵣ_{ⱼ}(t) is turned on, and can be chosen to be the same for all values of j. Lastly, the parameter tᵣ_{ⱼ} determines when λᵣ_{ⱼ}(t) is turned off and will depend on the value of j. In order to get diverse samples, the difference may be set as follows,

$${t}_{{r}_{j + 1}} - {t}_{{r}_{j}} = {ατ}_{therm}^{( y )} ,$$

(equation 3), where

$${τ}_{therm}^{( y )}$$

is the thermal equilibrium time of the oscillator ϕ_{y}, and a is some constant that is chosen from numerical simulations.

In some embodiments, as the coupling parameter λᵣ_{ⱼ}(t) is turned off, the product

$${m}_{r} ( t ) {ω}_{r}^{2} ( t )$$

of the oscillator ϕᵣ_{ⱼ} may be adjusted (e.g., tuned) to effectively freeze it's position degree of freedom at a sampled value from ϕ_{y}. For instance, using a Cooper-pair box, the mass mᵣ(t) may be increased to be large enough such that

$${m}_{r} {ω}_{r}^{2} ≫ {\tilde{m}}_{r} {\tilde{ω}}_{r}^{2}$$

in addition to ensuring that ϕᵣ_{ⱼ} is nearly frozen at the sampled value when λᵣ_{ⱼ}(t) is turned off. Note that a bias oscillator may be used to help ϕᵣ_{ⱼ} maintain its sampled value from ϕ_{y} when λᵣ_{ⱼ}(t) is turned off. For example, the coupling between ϕᵣ_{ⱼ} and the bias oscillator ϕ_{b}_{ⱼ} may be simultaneously turned on while adjusting (e.g., tuning) the product

$${m}_{r} ( t ) {ω}_{r}^{2} ( t )$$

(see equation 1 which describes the coupling between ϕᵣ_{ⱼ} and ϕ_{b}_{ⱼ}).

For example, after respective ones of the {ϕᵣ_{₁}, ϕ_{rϕ2}, . . . ϕᵣ_{_{N}}} oscillators are decoupled from ϕ_{y} and their position degrees of freedom are frozen to a sampled value of ϕ_{y}, the coupling

$${λ}_{{r}_{N + 1}} ( t )$$

in equation 1 may be turned on. As in equation 2, the coupling signal may be chosen such that,

$${λ}_{{r}_{N + 1}} ( t ) = {λ}_{{r}_{N + 1}} ( σ ( {k}_{r} ( t - {t}_{1} ) ) - σ ( {k}_{r} ( t - {t}_{2} ) ) ) ,$$

(equation 4) with

$${t}_{1} > {t}_{{r}_{N}} .$$

In what follows, since

$${m}_{r} {ω}_{r}^{2} ≫ {\tilde{m}}_{r} {\tilde{ω}}_{r}^{2} ,$$

the oscillators {ϕᵣ_{₁}, ϕᵣ_{₂}, . . . ϕᵣ_{_{N}}} may be treated as static at the value obtained from their coupling to ϕ_{y}. For notational simplicity, set the value as ϕᵣ_{ⱼ}=yⱼ for 1≤j≤N. Given these assumptions, the equilibrium value of

$${ϕ}_{{r}_{N + 1}}$$

may be approximated (ignoring the bias term for now) as,

$$〈 {ϕ}_{{r}_{N + 1}} 〉 \approx \frac{\int d {ϕ}_{{r}_{N + 1}} {ϕ}_{{r}_{N + 1}} {e}^{- β {V}_{{r}_{N + 1}}}}{\int d {ϕ}_{{r}_{N + 1}} {e}^{- β {V}_{{r}_{N + 1}}}} = \frac{{λ}_{{r}_{N + 1}}}{N {λ}_{{r}_{N + 1}} + \frac{1}{2} {\tilde{m}}_{r} ( t ) {{\tilde{ω}}_{r} ( t )}^{2}} {\sum }_{j = 1}^{N} {y}_{j} ,$$

(equation 5), where it is defined that,

$${V}_{{r}_{N + 1}} ≡ \frac{1}{2} {\tilde{m}}_{r} ( t ) {{\tilde{ω}}_{r} ( t )}^{2} {ϕ}_{{r}_{N + 1}}^{2} + {λ}_{{r}_{N + 1}} {\sum }_{j = 1}^{N} {( {ϕ}_{{r}_{N + 1}} - {y}_{j} )}^{2} ,$$

(equation 6), and where the maximum value

$${λ}_{{r}_{N + 1}} of {λ}_{{r}_{N + 1}} ( t )$$

is used. As such, by setting

$$N {λ}_{{r}_{N + 1}} ≫ \frac{1}{2} {\tilde{m}}_{r} ( t ) {{\tilde{ω}}_{r} ( t )}^{2}$$

it is given that,

$$〈 {ϕ}_{{r}_{N + 1}} 〉 \approx \frac{1}{N} {\sum }_{j = 1}^{N} {y}_{j} \approx 〈 {ϕ}_{y} 〉 ,$$

(equation 7), which is the desired result as long as N is large enough and the yⱼ samples are not too correlated (which will depend on the choice of α in equation 3).

In some embodiments, once the oscillator

$${ϕ}_{{r}_{N + 1}}$$

reaches thermal equilibrium, the coupling

$${λ}_{{r}_{N + 1}} ( t )$$

may be turned off and the product \tilde{m}ᵣ(t)\tilde{ω}ᵣ(t)² may be adjusted (e.g., tuned) so that

$${ϕ}_{{r}_{N + 1}}$$

becomes effectively static at the equilibrium value in equation 7. Afterwords,

$${ϕ}_{{r}_{N + 1}}$$

may be coupled to the input neuron ϕₓ of the output module.

In some embodiments, the relevant gradients as well as components of the Bogoliubov-Kubo-Mori (BKM) metric may be stored in the position degree of freedom of relay oscillators using mean field approaches. Such gradients and components of the BKM metric can then be used to update the parameters of an EBM following an NGD protocol.

For example, the BKM metric meets desirable asymptotic optimality criteria. The BKM metric for energy based models is defined as,

$${{𝒥}^{BKM} ( θ )}_{j , k} = \int ( {\partial }_{{θ}_{j}} {p}_{θ} ( x ) ) ( {\partial }_{{θ}_{k}} log {p}_{θ} ( x ) ) d x ,$$

(equation 8), where p_{θ}(x)=exp(−ε_{θ}(x))/Z(θ). Using the definition of p_{θ}(x), both terms in equation 8 may be calculated. The first term results in,

$${\partial }_{{θ}_{j}} {p}_{θ} ( x ) = ( {E}_{z ∼ {p}_{θ} ( z )} [ {\partial }_{{θ}_{j}} {ε}_{θ} ( z ) ] - {\partial }_{{θ}_{j} {ε}_{θ}} ( i ) ) {p}_{θ} ( x ) ,$$

(equation 9), and the second term is given by,

$${\partial }_{{θ}_{k}} log {p}_{θ} ( x ) = ( - {\partial }_{{θ}_{k}} {ε}_{θ} ( x ) + {E}_{y ∼ {p}_{θ} ( y )} [ {\partial }_{{θ}_{k} {ε}_{θ}} ( y ) ] ) , \qquad ( equation 10 ) .$$

For example, putting equation 9 and equation 10 into equation 8 results in,

$${{𝒥}^{BKM} ( θ )}_{j , k} = {E}_{x ∼ {p}_{θ} ( x )} [ {\partial }_{{θ}_{j}} {ε}_{θ} ( x ) {\partial }_{{θ}_{k}} {ε}_{θ} ( x ) ] - {E}_{x ∼ {p}_{θ} ( x )} [ {\partial }_{{θ}_{j}} {ε}_{θ} ( x ) ] {E}_{y ∼ {p}_{θ} ( y )} [ {\partial }_{{θ}_{k}} {ε}_{θ} ( y ) ] , \qquad ( equation 11 ) .$$

For example, given the BKM metric in equation 11, the parameters may be updated according to,

$${θ}_{t + 1} = {θ}_{t} + \frac{1}{{λ}_{c}} {𝒥}^{+} ( {θ}_{t} ) ( - {∇}_{{θ}_{t} {ε}_{𝓅}} ( {θ}_{t} ) - N ( \frac{1}{n} {\sum }_{i = 1}^{n} {∇}_{{θ}_{t} ε} ( {θ}_{t} , {x}_{{t}_{i}} ) - {E}_{x ∼ {p}_{{θ}_{t}} ( x )} [ {∇}_{{θ}_{t} ε} ( {θ}_{t} , x ) ] ) ) ,$$

(equation 12), where λₜ is the learning rate and [symbol] ⁺(θ) is the Moore-Penrose pseudo-inverse of the information matrix [symbol] (θ). In some embodiments, a choice for the information matrix may be the BKM metric (e.g., [symbol] (θ)= [symbol] ^{BKM}(θ)).

In some embodiments, relay oscillators may be used to store information relating to components of an information matrix. For example, the term E_{x˜p}_{_{θ}}₍ₓ₎ [∂_{θ}_{ⱼ}ε_{θ}(x) ∂_{θ}_{ₖ}ε_{θ}(x)] in equation 11 can be stored in the position degree of freedom of a relay oscillator.

For example, consider the following potential energy function,

$${V}_{BKM}^{( 1 )} = \frac{1}{2} {m}_{r} ( t ) {{ω}_{r} ( t )}^{2} {\sum }_{j = 1}^{N} {ϕ}_{{r}_{j}}^{2} + \frac{1}{2} {\tilde{m}}_{r} ( t ) {{\tilde{ω}}_{r} ( t )}^{2} {ϕ}_{{r}_{N + 1}}^{2} + {ε}_{θ} ( x , z ) + {\sum }_{t = 1}^{N} {{λ}_{t}^{( 1 )} [ {ϕ}_{{r}_{t}} - {\partial }_{{θ}_{j} {ε}_{θ}} ( x , z ) {\partial }_{{θ}_{k} {ε}_{θ}} ( x , z ) ]}^{2} + {λ}_{{r}_{N + 1}} ( t ) {\sum }_{j = 1}^{N} {( {ϕ}_{{r}_{N + 1}} - {ϕ}_{{r}_{j}} )}^{2} + \frac{1}{2} {m}_{b} {ω}_{b}^{2} {\sum }_{j = 1}^{N} {ϕ}_{{b}_{j}}^{2} + \frac{1}{2} {\tilde{m}}_{b} {\tilde{ω}}_{b}^{2} {ϕ}_{{b}_{N + 1}}^{2} + {\sum }_{j = 1}^{N} {λ}_{{b}_{j}} ( t ) {ϕ}_{{b}_{j}} {ϕ}_{{r}_{j}} + {λ}_{{b}_{N + 1}} ( t ) {ϕ}_{{b}_{N + 1}} {ϕ}_{{r}_{N + 1}} ,$$

(equation 13), where ε_{θ}(x, z) is the potential energy function of the EBM of interest, and latent variables may be allowed. The couplings

$${λ}_{t}^{( 1 )}$$

may be turned on and off. Bias oscillators may also be used. Note that the above potential is similar to the one used in equation 1. However, instead of coupling the relay oscillators {ϕᵣ_{₁}, ϕᵣ_{₂}, . . . ϕᵣ_{_{N}}} to some output oscillator ϕ_{y} of the EBM ε_{θ}(x, z), such oscillators are coupled to a term of the form ∂_{θ}_{ⱼ}_{ε}_{_{θ}}(x, z) ∂_{θ}_{ₖ}_{ε}_{_{θ}}(x, z). Such a term requires a coupling between the relay oscillators ϕᵣ_{ⱼ} and all neurons which are coupled to the parameters θⱼ and θₖ. If the connectivity degree is too large, additional intermediate oscillators may be used to reduce the connectivity degree. Following similar steps as shown above and using the coupling parameters as in equations 2-4 results in,

$$\begin{matrix}〈 {ϕ}_{{r}_{N + 1}} 〉 \approx \frac{{λ}_{{r}_{N + 1}}}{N {λ}_{{r}_{N + 1}} + \frac{1}{2} {\tilde{m}}_{r} ( t ) {{\tilde{ω}}_{r} ( t )}^{2}} {\sum }_{j = 1}^{N} {\partial }_{{θ}_{j}} {ε}_{θ} ( {x}_{i} , {z}_{i} ) {\partial }_{{θ}_{k}} {ε}_{θ} ( {x}_{i} , {z}_{i} ) \\ \approx \frac{1}{N} {\sum }_{j = 1}^{N} {\partial }_{{θ}_{j}} {ε}_{θ} ( {x}_{i} , {z}_{i} ) {\partial }_{{θ}_{k}} {ε}_{θ} ( {x}_{i} , {z}_{i} ) \\ \approx {E}_{( x , z ) ∼ {p}_{θ} ( x , z )} [ {\partial }_{{θ}_{j}} {ε}_{θ} ( x , z ) {\partial }_{{θ}_{k}} {ε}_{θ} ( x , z ) ]\end{matrix} ,$$

(equation 14), where in going to the second line the condition

$$N {λ}_{{r}_{N + 1}} ≫ \frac{1}{2} {\tilde{m}}_{r} ( t ) {{\tilde{ω}}_{r} ( t )}^{2}$$

is used.

According to some embodiments, in order to obtain terms of the form E_{x˜p}_{_{θ}}₍ₓ₎ [∂_{θ}_{ⱼ}ε_{θ}(x)] which are required in equation 11 as well as for the negative phase term in equation 12, the following potential energy function may be used,

$${V}_{BKM}^{( 2 )} = \frac{1}{2} {m}_{r} ( t ) {{ω}_{r} ( t )}^{2} {\sum }_{j = 1}^{N} {ϕ}_{{r}_{j}}^{2} + \frac{1}{2} {\tilde{m}}_{r} ( t ) {{\tilde{ω}}_{r} ( t )}^{2} {ϕ}_{{r}_{N + 1}}^{2} + {ε}_{θ} ( x , z ) + {\sum }_{t = 1}^{N} {{λ}_{t}^{( 2 )} [ {ϕ}_{{r}_{t}} - {\partial }_{{θ}_{j} {ε}_{θ}} ( x , z ) ]}^{2} + {λ}_{{r}_{N + 1}} ( t ) {\sum }_{j = 1}^{N} {( {ϕ}_{{r}_{N + 1}} - {ϕ}_{{r}_{j}} )}^{2} + \frac{1}{2} {m}_{b} {ω}_{b}^{2} {\sum }_{j = 1}^{N} {ϕ}_{{b}_{j}}^{2} + \frac{1}{2} {\tilde{m}}_{b} {\tilde{ω}}_{b}^{2} {ϕ}_{{b}_{N + 1}}^{2} + {\sum }_{j = 1}^{N} {λ}_{{b}_{j}} ( t ) {ϕ}_{{b}_{j}} {ϕ}_{{r}_{j}} + {λ}_{{b}_{N + 1}} ( t ) {ϕ}_{{b}_{N + 1}} {ϕ}_{{r}_{N + 1}} , \qquad ( equation 15 ) .$$

The coupling

$${λ}_{t}^{( 2 )}$$

may be turned on and off as described above. Following similar steps leading to equation 14 results in,

$$〈 {ϕ}_{{r}_{N + 1}} 〉 \approx {E}_{( x , z ) ∼ {p}_{θ} ( , y )} [ {\partial }_{{θ}_{j} {ε}_{θ}} ( x , z ) ] , \qquad ( equation 16 ) .$$

According to some embodiments, let ϕᵣ_{ⱼ} and ϕᵣ_{ₖ} be the relay oscillators immediately above with equilibrium values given by E_{(x,z)˜p}_{_{θ}}_{(x,z)} [∂_{θ}_{ⱼ}ε_{θ}(x,z)] and E_{(x,z)˜p}_{_{θ}}_{(x,z)}[∂_{θ}_{ₖ}ε_{θ}(x,z)], and with masses mₜ and frequency ωₜ. Let

$${ϕ}_{{r}_{d}}^{( j , k )}$$

be the final relay oscillator with the equilibrium value given in equation 14, and with mass m_{d} and frequency ω_{d}. For example, consider a third relay oscillator labeled

$${ϕ}_{{r}_{f}}^{( j , k )}$$

with mass m_{f} and frequency θ_{f}, and where

$${m}_{f} {ω}_{f}^{2} ≪ {m}_{t} {ω}_{t}^{2} and {m}_{f} {ω}_{f}^{2} ≪ {m}_{d} {ω}_{d}^{2} .$$

Thus, the oscillators

$${ϕ}_{{r}_{j}} and {ϕ}_{{r}_{k}}$$

may be treated as static at their equilibrium values relative to the oscillator

$${ϕ}_{{r}_{f}}^{( j , k )} .$$

The coupling between

$${ϕ}_{{r}_{f}}^{( j , k )}$$

and the oscillators

$${ϕ}_{{r}_{t}}^{( j , k )} and {ϕ}_{{r}_{d}}^{( j , k )}$$

is described by the following potential,

$${V}_{BKM}^{( 3 )} = \frac{1}{2} {m}_{f} {{ω}_{f}^{2} ( {ϕ}_{{r}_{f}}^{( j , k )} )}^{2} + {λ}_{3} ( t ) {( {ϕ}_{{r}_{f}}^{( j , k )} - ( {ϕ}_{{r}_{d}}^{( j , k )} - {ϕ}_{{r}_{j}} {ϕ}_{{r}_{k}} ) )}^{2} . \qquad ( equation 17 )$$

Following similar steps as shown above, the following may result,

$$〈 {ϕ}_{{r}_{f}}^{( j , k )} 〉 = \frac{2 {λ}_{3}}{2 {λ}_{3} + {m}_{f} {ω}_{f}^{2}} ( {E}_{( x , z ) ∼ {p}_{θ} ( x , z )} [ {\partial }_{{θ}_{j}} {ε}_{θ} ( x , z ) {\partial }_{{θ}_{k}} {ε}_{θ} ( x , z ) ] - {E}_{( x , z ) ∼ {p}_{θ} ( x , z )} [ {\partial }_{{θ}_{j}} {ε}_{θ} ( x , z ) ] {E}_{( x , z ) ∼ {p}_{θ} ( x , z )} [ {\partial }_{{θ}_{k} {ε}_{θ}} ( x , z ) ] ) , . \qquad ( equation 18 )$$

In some embodiments, if the coupling strength is large enough such that

$${λ}_{3} ≫ \frac{{m}_{f} {ω}_{f}^{2}}{2} ,$$

the desired expectation value may be obtained. The coupling λ₃ may be turned on (say following the pulse shape in equation 2) at the end of the steps resulting in equation 18 when the oscillator

$${ϕ}_{{r}_{t}}^{( j , k )}$$

has reached its equilibrium value and the product

$${m}_{t} {ω}_{t}^{2}$$

has been tuned such that the oscillator remains static relative to

$${ϕ}_{{r}_{f}}^{( j , k )} .$$

### After

$${ϕ}_{{r}_{f}}^{( j , k )}$$

reaches its equilibrium value, the coupling λ₃(t) is turned off. Bias oscillators may be used in equation 17 to assist the oscillator

$${ϕ}_{{r}_{f}}^{( j , k )}$$

in maintaining its equilibrium value after λ₃(t) is turned off. At the conclusion of the steps leading to equation 18, the oscillator

$${ϕ}_{{r}_{f}}^{( j , k )}$$

encodes the (j, k)^{th} component of the BKM matrix in equation 11.

According to some embodiments, a layer-wise Fisher construction is utilized. For example, consider a deep EBM architecture. That is, several EBM blocks are provided, with block l having parameters θₗ. A block diagonal approximation to the [symbol] ^{BKM}(θ) matrix in equation 11 may be constructed by only considering matrix elements [symbol] ^{BKM}(θ)_{j,k} in a given EBM block, and setting all other components to zero. For example, only relay oscillators leading to equation 18 are used that are coupled in a given EBM block, and couplings in between blocks of EBMs are avoided.

In some embodiments, in order to perform the fully analogue version of NGD presented herein, relay oscillators that have equilibrium values given in equation 16 for the negative phase term in equation 12 as well as relay oscillators which reach equilibrium at the positive phase term are needed (where the visible neurons are clamped to some dataset). Consider a mini-batch X containing n≥1 elements of the dataset, wherein a mini-batch is a subset of training data to be used to train the model. For the positive phase term, consider a potential similar to the one in equation 15, but which has the form,

$${V}_{BKM}^{( 2 , p )} = \frac{1}{2} {m}_{r} ( t ) {{ω}_{r} ( t )}^{2} {\sum }_{k = 1}^{N} {\sum }_{i = 1}^{n} {ϕ}_{{r}_{k , i}}^{2} + \frac{1}{2} {m}_{r}^{( {p}_{j} )} ( t ) {( {ω}_{r}^{( {p}_{j} )} ( t ) )}^{2} {( {ϕ}_{{r}_{N + n + 1}}^{( {p}_{j} )} )}^{2} + {\sum }_{l = 1}^{n} {λ}_{i} ( t ) {ε}_{θ} ( {x}_{i} , z ) + {\sum }_{k = 1}^{N} {\sum }_{i = 1}^{n} {{λ}_{k , i}^{( 2 , p )} ( t ) [ {ϕ}_{{r}_{k , i}} - \frac{1}{n} {\partial }_{{θ}_{j} {ε}_{θ}} ( {x}_{i} , z ) ]}^{2} + {λ}_{{r}_{N + 1}} ( t ) {\sum }_{k = 1}^{N} {\sum }_{i = 1}^{n} {( {ϕ}_{{r}_{N + n + 1}}^{( {p}_{j} )} - {ϕ}_{{r}_{k , i}} )}^{2} + \frac{1}{2} {m}_{b} {ω}_{b}^{2} {\sum }_{j = 1}^{N} {\sum }_{i = 1}^{n} {ϕ}_{{b}_{j , i}}^{2} + \frac{1}{2} {\tilde{m}}_{b} {\tilde{ω}}_{b}^{2} {ϕ}_{{b}_{N + n + 1}}^{2} + {\sum }_{j = 1}^{N} {\sum }_{i = 1}^{n} {λ}_{{b}_{j , i}} ( t ) {ϕ}_{{b}_{j , i}} {ϕ}_{{r}_{j , i}} + {λ}_{{b}_{N + n + 1}} ( t ) {ϕ}_{{b}_{N + n + 1}} {ϕ}_{{r}_{N + n + 1}}^{( {p}_{j} )} ,$$

(equation 19), where the couplings

$${λ}_{k , i}^{( 2 , p )} ( t )$$

are turned on and off. Note that the superscript (pⱼ) used for the oscillator

$${ϕ}_{{r}_{N + n + 1}}^{( {p}_{j} )}$$

indicates that it is used to encode the positive phase term when the gradient is taken with respect to θⱼ. Repeating the similar steps leading to equation 16 leads to,

$${ϕ}_{{r}_{N + n + 1}}^{( {p}_{j} )} \approx \frac{1}{n} {\sum }_{i = 1}^{n} {E}_{z ∼ p θ ( Z \vert {X}_{i} )} [ {\partial }_{{θ}_{j}} {ℰ}_{θ} ( {x}_{i} , z ) ] ,$$

(equation 20), which is the desired result for the positive phase term. Note that temporal or sequenced based relay oscillator methods may be used to obtain the result in equation 20 instead of the spatial one considered in this section, which would avoid the double sum in equation 19 which may be costly in terms of space overhead. For example, the sum over N corresponds to the number of relay oscillators used in the protocol. A larger number of relay oscillators may become prohibitively expensive in terms of space occupied on the thermodynamic chip(s). Some relay protocols may require fewer relay oscillators to obtain the result of equation 20. In some embodiments, in the absence of latent variables, multiple samples for each xᵢϵ [symbol] may not be required since the gradient does not require an expectation value over the latent variables. As such, the potential in equation 19 for the spatial relay oscillator scheme can be simplified to,

$${V}_{BKM}^{( 2 ,} = \frac{1}{2} {m}_{r} ( t ) {{ω}_{r} ( t )}^{2} {\sum }_{i = 1}^{n} {ϕ}_{{r}_{i}}^{2} + {\sum }_{i = 1}^{n} {λ}_{i} ( t ) {ℰ}_{θ} ( {x}_{i} ) + {\sum }_{i = 1}^{n} {{λ}_{i}^{( 2 , p )} ( t ) [ {ϕ}_{{r}_{i}} - \frac{1}{n} {\partial }_{{θ}_{j}} {ℰ}_{θ} ( {x}_{i} ) ]}^{2} + \frac{1}{2} {m}_{b} {ω}_{b}^{2} {\sum }_{j = 1}^{n} {ϕ}_{{b}_{j}}^{2} + {\sum }_{j = 1}^{n} {λ}_{{b}_{j}} ( t ) {ϕ}_{{b}_{j}} {ϕ}_{{r}_{j}} + \frac{1}{2} {m}_{r}^{( {p}_{j} )} ( t ) {( {ω}_{r}^{( {p}_{j} )} ( t ) )}^{2} {( {ϕ}_{{r}_{n + 1}}^{( {p}_{j} )} )}^{2} + \frac{1}{2} {\tilde{m}}_{b} {\tilde{ω}}_{b}^{2} {ϕ}_{{b}_{n + 1}}^{2} + {λ}_{{r}_{n + 1}} ( t ) {\sum }_{i = 1}^{n} {( {ϕ}_{{r}_{n + 1}}^{( i , {p}_{j} )} - {ϕ}_{{r}_{i}} )}^{2} + {λ}_{{b}_{n + 1}} ( t ) {ϕ}_{{b}_{n + 1}} {ϕ}_{{r}_{N + n + 1}}^{( {p}_{j} )} , and , \qquad ( equation 21 )$$

$${ϕ}_{{r}_{N + n + 1}}^{( {p}_{j} )} \approx \frac{1}{n} {\sum }_{i = 1}^{n} {\partial }_{{θ}_{j}} {ℰ}_{θ} ( {x}_{i} ) , \qquad ( equation 22 )$$

In some embodiments, a relay oscillator may be used to combine positive and negative phase terms. For example, to obtain the appropriate parameter update rule in the fully analogue NGD scheme described herein, another relay oscillator is introduced which is coupled to the oscillator

$${ϕ}_{{r}_{N + n + 1}}^{( {p}_{j} )}$$

(which has the equilibrium value given by equation 20) as well as the oscillator

$${ϕ}_{r}^{( j )}$$

which has the equilibrium value given in equation 16. Let

$${m}_{r}^{( {p}_{j} )} and {ω}_{r}^{( {p}_{j} )}$$

be the mass and frequency of the oscillator

$${ϕ}_{{r}_{N + n + 1}}^{( {p}_{j} )} .$$

Similarly define

$${m}_{r}^{( j )} and {ω}_{r}^{( j )}$$

to be the mass and frequency of the oscillator

$${ϕ}_{r}^{( j )} .$$

Define the third relay oscillator as

$${ϕ}_{r}^{( j , u )}$$

with mass and frequency given by

$${m}_{r}^{( j , u )} and {ω}_{r}^{( j , u )} .$$

Since the product of mass time frequency squared of the oscillators

$${ϕ}_{{r}_{N + n + 1}}^{( {p}_{j} )} and {ϕ}_{r}^{( j )}$$

are tuned to ensure they remain static at the equilibrium values in equations 16 and 20, assume that

$${{m}_{r}^{( j , u )} ( {ω}_{r}^{( j , u )} )}^{2} << {m}_{r}^{( {p}_{j} )} {( {ω}_{r}^{( {p}_{j} )} )}^{2} and {{m}_{r}^{( j , u )} ( {ω}_{r}^{( j , u )} )}^{2} << {m}_{r}^{( j )} {( {ω}_{r}^{( j )} )}^{2} .$$

For example, treat the oscillators

$${ϕ}_{{r}_{N + n + 1}}^{( {p}_{j} )} and {ϕ}_{r}^{( j )}$$

and as static relative to

$${ϕ}_{r}^{( j , u )} .$$

The potential describing the coupling is given by,

$${V}_{BKM}^{( 2 , u )} = \frac{1}{2} {{m}_{r}^{( j , u )} ( {ω}_{r}^{( j , u )} )}^{2} {ϕ}_{r}^{( j , u )} + {λ}^{( 2 , u )} ( t ) {( {ϕ}_{r}^{( j , u )} - ( {ϕ}_{r}^{( j )} - {ϕ}_{{r}_{N + n + 1}}^{( {p}_{j} )} ) )}^{2} , \qquad ( equation 23 )$$

Following similar steps as shown in the steps leading to equation 18 provides,

$$〈 {ϕ}_{r}^{( j , u )} 〉 \approx - \frac{2 {λ}^{( 2 , u )}}{2 {λ}^{( 2 , u )} + {{m}_{r}^{( j , u )} ( {ω}_{r}^{( j , u )} )}^{2}} ( \frac{1}{n} {\sum }_{i = 1}^{n} {E}_{z ∼ {p}_{θ} ( z \vert {x}_{i} )} [ {\partial }_{{θ}_{j}} {ε}_{θ} ( {x}_{i} , z ) ] - {E}_{( x , z ) ∼ {p}_{θ} ( x , z )} [ {\partial }_{{θ}_{j}} {ε}_{θ} ( x , z ) ] ) ,$$

(equation 24), which gives the desired result when

$${λ}^{( 2 , u )} >> {{m}_{r}^{( j , u )} ( {ω}_{r}^{( j , u )} )}^{2} .$$

Later it will be shown that an appropriate choice is to set λ^{(2,u)}=N to get the correct parameter update rules in equation 12, which is valid as long as

$$N >> {{m}_{r}^{( j , u )} ( {ω}_{r}^{( j , u )} )}^{2} .$$

In some embodiments, natural gradient descent may be implemented. For example, suppose there are a total of M parameters, e.g., θ=(θ₁, θ₂, . . . , θ_{M}). Consider the set of M oscillators

$${ϕ}_{r}^{( u )} = ( {ϕ}_{r}^{( 1 , u )} , {ϕ}_{r}^{( 2 , u )} , … , {ϕ}_{r}^{( M , u )} ) where 〈 {ϕ}_{r}^{( j , u )} 〉$$

is given in equation 24. The mass and frequency of the oscillator

$${ϕ}_{r}^{( j , u )}$$

may be labeled as

$${m}_{r}^{( j , u )} and {ω}_{r}^{( j , u )} .$$

Consider a set of M′×M′ oscillators

$${ϕ}_{{r}_{f}} = ( {ϕ}_{{γ}_{f}}^{( 1 , 1 )} , {ϕ}_{{r}_{f}}^{( 1 , 2 )} , … , {ϕ}_{{r}_{f}}^{( M , M )} )$$

where M′≤M and where the equilibrium value of

$${ϕ}_{{r}_{f}}^{( j , k )}$$

is given in equation 18. Note that when using the block-diagonal approximation to the Fisher information matrix, M′<M. Also label the mass and frequencies of the oscillators

$${ϕ}_{{r}_{f}}^{( j , k )}$$

as m_{f} and ω_{f}. For notational simplicity, write the oscillators ϕᵣ_{_{f}} in matrix form as,

$${B}_{{r}_{f}} = [ \begin{matrix}{ϕ}_{{r}_{f}}^{( 1 , 1 )} & {ϕ}_{{r}_{f}}^{( 1 , 2 )} & … & {ϕ}_{{r}_{f}}^{( 1 , M )} \\ {ϕ}_{{r}_{f}}^{( 2 , 1 )} & {ϕ}_{{r}_{f}}^{( 2 , 2 )} & … & {ϕ}_{{r}_{f}}^{( 2 , M )} \\ … & … & … & … \\ {ϕ}_{{r}_{f}}^{( M , 1 )} & {ϕ}_{{r}_{f}}^{( M , 2 )} & … & {ϕ}_{{r}_{f}}^{( M , m )}\end{matrix} ] . \qquad ( equation 25 )$$

In some embodiments, if a block diagonal approximation to Bᵣ_{_{f}} is used, then M′<M (since not all elements M×M of the full matrix are used), and the entries in Bᵣ_{_{f}} where no relay oscillators are used may be set to zero.

In some embodiments, consider a series of oscillators with position degrees of freedom described by the vector ϕ_{δ}=(ϕ_{δ}_{₁}, ϕ_{δ}_{₂}, . . . , ϕ_{δ}_{_{M}}). Wherein, the mass and frequencies of these oscillators are denoted as m_{δ} and ω_{δ} which satisfy

$${m}_{δ} {ω}_{δ}^{2} << {m}_{r}^{( j , u )} ( {ω}_{r}^{( j , u )} ) and {m}_{δ} {ω}_{δ}^{2} << {m}_{f} {ω}_{f}^{2} .$$

The last two conditions arise from the fact that

$${ϕ}_{r}^{( u )}$$

and ϕᵣ_{_{f}} are relay oscillators whose product of mass times frequency squared is tuned such that they remain static after reaching the thermal equilibrium values in equations 18 and 24, respectively. Now consider the following coupling potential between ϕ_{δ} and the oscillators

$${ϕ}_{r}^{( u )}$$

and ϕᵣ_{_{f}} which are treated as static at their equilibrium values,

$${V}_{δ} = {ϕ}_{r}^{( u )} {ϕ}_{δ}^{T} + {ϕ}_{δ} {B}_{{r}_{f}} {ϕ}_{δ}^{T} . \qquad ( equation 26 )$$

In some embodiments, when computing the equilibrium dynamics of ϕ_{δ}, given the above conditions, replace

$${ϕ}_{r}^{( u )} \to 〈 {ϕ}_{r}^{( u )} 〉 and {B}_{{r}_{f}} \to 〈 {B}_{{r}_{f}} 〉 .$$

To compute [symbol] ϕ_{δ} [symbol] , use,

$$〈 {ϕ}_{δ} 〉 = \frac{\int d {ϕ}_{δ} {ϕ}_{δ} {e}^{- β {V}_{δ}}}{\int d {ϕ}_{δ} {e}^{- β {V}_{δ}}} ,$$

(equation 27). To evaluate the integral in equation 27, consider the potential V_{δ} is such that e^{-βV}^{_{δ}}/Z (where Z=∫dϕ_{δ}e^{-βV}^{_{δ}}) is a Gaussian distribution when using the expectation values for

$${ϕ}_{r}^{( u )}$$

and Bᵣ_{_{f}}. A Gaussian distribution for a random variable x of length N has probability distribution given by,

$$p ( x ) = \frac{1}{{( 2 π )}^{N / 2} {\vert Σ \vert}^{1 / 2}} exp - \frac{1}{2} {( x - μ )}^{T} {Σ}^{- 1} ( x - μ ) ,$$

(equation 28), with mean p and covariance matrix Σ. Expanding the exponent in equation 28 and matching it to −βV_{δ} (with the expectation values used for ϕᵣ^{(u)} and Bᵣ_{_{f}}), results in the following (ignoring constant terms as they don't affect the statistics),

$$Σ = \frac{1}{2 β} 〈 {B}_{{r}_{f}}^{- 1} 〉 , \qquad ( equation 29 )$$

$$and ,$$

$$μ = - \frac{1}{2} 〈 {B}_{{r}_{f}}^{- 1} 〉 〈 {ϕ}_{r}^{( u )} 〉 . \qquad ( equation 30 )$$

In some embodiments, and from equation 30,

$$〈 {ϕ}_{δ} 〉 \approx - \frac{1}{2} 〈 {B}_{{r}_{f}}^{- 1} 〉 〈 {ϕ}_{r}^{( u )} 〉 ,$$

(equation 31), where the approximation label arises from the fact that the expectation values for

$${ϕ}_{r}^{( u )}$$

and Bᵣ_{_{f}} were used. Furthermore, the variance may be described by,

$$Var ( {ϕ}_{δ} ) = \frac{1}{2 β} 〈 {B}_{{r}_{f}}^{- 1} 〉 , \qquad ( equation 32 ) .$$

In some embodiments, parameters may be updated in a fully analogue implementation. For example, in equation 31,

$$〈 {B}_{{r}_{f}}^{- 1} 〉$$

maps to [symbol] ⁺(θ) (e.g., the result in equation 18 and

$$〈 {ϕ}_{r}^{( u )} 〉$$

maps to

$$N ( \frac{1}{n} {\sum }_{i = 1}^{n} {∇}_{{θ}_{t}} ε ( {θ}_{t} , {x}_{{t}_{i}} ) - {E}_{x ∼ {p}_{{θ}_{t}} ( x )} [ {∇}_{{θ}_{t}} ε ( {θ}_{t} , x ) ] ) ,$$

See equation 24). For example, if the parameters are taken to be dynamical degrees of freedom and the coupling between said oscillators and ϕ_{δ} are quickly turned on, the correct parameter update rule of equation 12 may be obtained (in expectation value), although the noise term will be determined by the variance in ϕ_{δ} given by equation 32. For example, let ϕ_{θ} denote the position degrees of freedom of the oscillators which encode the parameters θ. Consider a potential given by,

$${V}_{p a r a m} ( θ , δ ) = \frac{1}{2} {m}_{θ} ( t ) {{ω}_{θ} ( t )}^{2} {\sum }_{j = 1}^{M} {( {ϕ}_{{θ}_{j}} - {θ}_{0}^{( j )} )}^{2} + {λ}_{θ} ( t ) {\sum }_{j = 1}^{M} {ϕ}_{{θ}_{j}} {ϕ}_{{δ}_{j}} + \frac{1}{2} {m}_{( b , θ )} {ω}_{( b , θ )}^{2} {\sum }_{j = 1}^{M} {ϕ}_{{b}_{j}}^{( θ )} + {λ}_{( b , θ )} ( t ) {\sum }_{j = 1}^{M} {ϕ}_{{θ}_{j}} {ϕ}_{{b}_{j}}^{( θ )} + {V}_{δ} ,$$

(equation 33), where V_{δ} is given in equation 26 and θ₀ are the initial values chosen for the parameters θ (and

$${θ}_{0}^{( j )}$$

is the j^{th} component of the vector θ₀). Bias oscillators

$${ϕ}_{{b}_{j}}^{( θ )}$$

may be used, but these should be treated as optional. Also consider a regime where

$${m}_{θ} {ω}_{θ}^{2}$$

is to be large enough such that the dynamics of the oscillators ϕ_{θ} are considered static during all the steps leading to the thermal equilibrium value of ϕ_{δ} in equation 31. The coupling λ_{θ}(t) in equation 33 is turned on after ϕ_{δ} reaches thermal equilibrium, and then turned off after ϕ_{θ} reach their new equilibrium values (we may for instance use a pulse shape as in equation 2). Bias oscillators may be used in equation 33 to help maintain the new equilibrium values of the oscillators ϕ_{θ} (e.g., to further slow down the decay from the new equilibrium values of ϕ_{θ} back to the original equilibrium values they had prior to turning on the coupling with ϕ_{δ}). In some embodiments, the coupling λ_{(b,θ)}(t) for the bias oscillators are used in the same manner as if ϕ_{θ} were relay oscillators.

From equation 33, when the coupling λ_{θ}(t) is turned on and reaches its maximum value (say λ_{θ}), the following results,

$$〈 {ϕ}_{θ} 〉 = \frac{\int d {ϕ}_{θ} d {ϕ}_{δ} {ϕ}_{θ} {e}^{- β {V}_{p a r a m} ( θ , δ )}}{\int d {ϕ}_{θ} d {ϕ}_{δ} {e}^{- β {V}_{p a r a m} ( θ , δ )}} \approx {θ}_{0} - η 〈 {B}_{{r}_{f}}^{- 1} 〉 〈 {ϕ}_{r}^{( u )} 〉 ,$$

(equation 34), where the approximation arises from the fact that expectation values

$$〈 {B}_{{r}_{f}}^{- 1} 〉 and 〈 {ϕ}_{r}^{( u )} 〉$$

are used. Furthermore,

$${λ}_{θ} = - 2 η {m}_{θ} {ω}_{θ}^{2}$$

is set as well as the condition,

$$2 η {m}_{θ} {ω}_{θ}^{2} ≪ min \vert {B}_{{r}_{f}} \vert ,$$

(equation 35), are used, which can be achieved for small η. For example, η may be related to the learning rate 1/λₜ in equation 12.

In some embodiments, the above process may be repeated each time ϕ_{δ} reaches a new equilibrium value when the parameters change due to the coupling in equation 33. A summary of the full exemplary protocol, starting from equation 13 and leading to equation 34 may be provided in what immediately follows.

For example, suppose there are M parameters θ=(θ₁, . . . , θ_{M}). Initialize the position degrees of freedom ϕ_{θ} which encodes the parameters θ to θ₀, where θ₀ is chosen from some prior distribution. Ensure that

$${m}_{θ} {ω}_{θ}^{2}$$

is large enough such that ϕ_{θ} remains approximately static when un-coupled from ϕ_{δ}.

Let S denote the total number of parameter update steps.

For each s in steps 1 to S:

Step 1: Use a relay oscillator protocol (e.g., such as a spatial relay protocol, temporal relay protocol, or sequence relay protocol) along with a corresponding coupling potential (e.g., the potential of equation 13 if a spatial analogue relay oscillator scheme is used). Let

$${ϕ}_{{r}_{1}}^{( j , k )}$$

be the final relay oscillators with equilibrium values given in equation 14 (e.g., an expectation value of a product of gradients, or synapse pair gradients), where the indices (j, k) indicate the corresponding row and column on the matrix [symbol] ^{BKM}(θ) in equation 11. Tune the product of mass times frequency squared of

$${ϕ}_{{r}_{1}}^{( j , k )}$$

(along with the possible use of bias oscillators) such that it remains static at the equilibrium value in equation 14 after being decoupled.

Step 2: Use a relay oscillator protocol (e.g., such as a spatial relay protocol, temporal relay protocol, or sequence relay protocol) along with a corresponding coupling potential (e.g., the potential of equation 15 if a spatial analogue relay oscillator scheme is used). Let

$${ϕ}_{{r}_{2}}^{( j )}$$

be the final relay oscillators with equilibrium values given in equation 16 (e.g., expectation value of a gradient term, or synapse gradient), where the index j spans over the total number of parameters. Tune the product of mass times frequency squared of

$${ϕ}_{{r}_{2}}^{( j )}$$

(along with the possible use of bias oscillators) such that it remains static at the equilibrium value in equation 16 after being decoupled.

Step 3: Let

$${ϕ}_{{r}_{3}}^{( j , k )}$$

be relay oscillators coupled to the relay oscillators

$${ϕ}_{{r}_{1}}^{( j , k )} , {ϕ}_{{r}_{2}}^{( j )} and {ϕ}_{{r}_{2}}^{( k )} , wherein {ϕ}_{{r}_{2}}^{( k )}$$

corresponds to relay oscillators configured by a similar process of establishing the relay oscillators corresponding to

$${ϕ}_{{r}_{2}}^{( j )} .$$

(e.g., use the potential of equation 17 if a spatial analogue relay oscillator scheme is used such that

$${ϕ}_{{r}_{3}}^{( j , k )}$$

reaches the thermal equilibrium value given by equation 18). Tune the product of mass times frequency squared of

$${ϕ}_{{r}_{3}}^{( j , k )}$$

(along with the possible use of bias oscillators) such that it remains static at the equilibrium value in equation 18 after being decoupled.

Step 4: Use a relay oscillator protocol (e.g., such as a spatial relay protocol, temporal relay protocol, or sequence relay protocol) along with a corresponding coupling potential (e.g., the potential of equation 19 if a spatial analogue relay oscillator scheme is used). Let

$${ϕ}_{{r}_{N + n + 1}}^{( {p}_{j} )}$$

be the final relay oscillators with equilibrium values given in equation 20 (e.g., expectation value of a gradient term corresponding to a positive phase term), where the index j spans over the total number of parameters. Tune the product of mass times frequency squared of

$${ϕ}_{{r}_{N + n + 1}}^{( {p}_{j} )}$$

(along with the possible use of bias oscillators) such that it remains static at the equilibrium value in equation 20 after being decoupled. Note that step 3 and step 4 may be performed simultaneously.

Step 5: Let

$${ϕ}_{r}^{( j , u )}$$

be relay oscillators coupled to the relay oscillators

$${ϕ}_{{r}_{N + n + 1}}^{( {p}_{j} )} and {ϕ}_{{r}_{2}}^{( j )}$$

(e.g., use the potential of equation 23 if a spatial analogue relay oscillator scheme is used such that

$${ϕ}_{r}^{( j , u )}$$

reaches the thermal equilibrium value given by equation 24). Tune the product of mass times frequency squared of

$${ϕ}_{r}^{( j , u )}$$

(along with the possible use of bias oscillators) such that it remains static at the equilibrium value in equation 24 after being decoupled.

Step 6: Let ϕ_{δ}=(ϕ_{δ}_{₁}, ϕ_{δ}_{₂}, . . . , ϕ_{δ}_{_{M}}) be relay oscillators coupled to the oscillators

$${ϕ}_{r}^{( u )} = ( {ϕ}_{r}^{( 1 , u )} , … , {ϕ}_{r}^{( M , u )} )$$

and the oscillators

$${ϕ}_{{r}_{3}}^{( j , k )}$$

(of step 3, and which are written in matrix form with the matrix labelled Bᵣ_{_{f}}) as described by the potential in equation 26. Also consider the coupling of the oscillators ϕ_{θ} to ϕ_{δ} as described by the potential in equation 33. For example, ϕ_{δ} may be viewed as relay oscillators and a relay oscillator protocol may be used such that the expectation value of ϕ_{θ} gets updates as,

$${ϕ}_{{θ}_{s}} = {ϕ}_{{θ}_{s - 1}} - η {B}_{{r}_{f}}^{- 1} {ϕ}_{r}^{( u )} ,$$

(equation 36), where the subscript s is used to denote the current iteration step. The coupling reaches a maximum value of

$${λ}_{θ} = - 2 η {m}_{θ} {ω}_{θ}^{2}$$

when turned on and η, which can be viewed as the learning rate, is chosen to satisfy

$$2 η {m}_{θ} {ω}_{θ}^{2} << min \vert {B}_{{r}_{f}} \vert .$$

The parameters are shifted by an amount which may differ from equation 36 due to the variances of ϕ_{δ} given in equation 32 as well as those associated with the equilibrium dynamics of ϕ_{θ}.

Also, in some embodiments, synapse parameters may be updated on an external classical post-processing device. For example, in some embodiments, the parameters θ may be defined as dynamical degrees of freedom whose values are encoded in the position degrees of freedom ϕ_{θ}. The dynamics of ϕ_{θ} may be chosen to be approximately static by choosing the product m_{θ}ω_{θ}² to be very large relative to the other oscillators of the system (e.g., the oscillators encoding the visible and hidden neurons as well as the relay oscillators prior to tuning their product of mass times frequency squared). Alternatively, according to some embodiments, the parameters θ may be treated as constants which get updated in software (e.g., values are not encoded in the position degrees of freedom of oscillators). To perform a temporal protocol using a classical computer, the same steps can be performed, such as steps 1 through step 6 above which lead to equation 31 for the oscillators ϕ_{δ}. Once the oscillators ϕ_{δ} reach their equilibrium values given in equation 31. In such a case, a single measurement is made for all the oscillators ϕ_{δ} to obtain a noisy sample (recall the variance in equation 32). Such a sample can be defined to be given by δₛ. The parameters may be updated on an external classical post-processing device (e.g., classical computer) as,

$${θ}_{k + 1} = {θ}_{k} - {ηδ}_{s} ,$$

(equation 37), for some learning rate η, and where the subscript k indicates the iteration step. Such a protocol is equivalent to the parameter update rule in equation 12 where noise may be added due to the variance given by equation 32. Such a protocol may be repeated with the newly computed values θₖ₊₁ by updating all potentials ε_{θ}(x, z) of the EBMs until convergence of a particular learning algorithm.

In some embodiments, instead of performing a single measurement of the oscillators ϕ_{δ}, multiple measurements may be performed of ϕ_{δ} after reaching equilibrium in order to reduce the variance. Define the j^{th} measurement as

$${δ}_{s}^{( j )} .$$

Suppose a total of K measurements are performed. The parameters may be updated on an external classical post-processing device as,

$${θ}_{k + 1} = {θ}_{k} - η {\sum }_{j = 1}^{K} {δ}_{s}^{( j )} ,$$

(equation 38), and repeat the above steps with the newly computed parameters until convergence of a learning algorithm.

In some embodiments, the systems and methods described above may be implemented using thermodynamic chips as further described below.

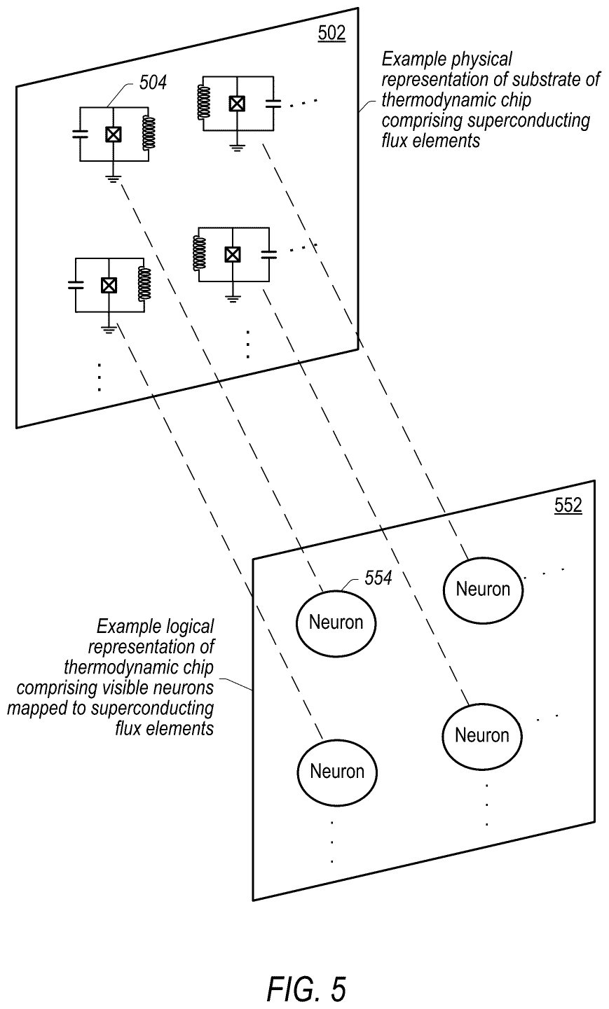

FIG. 5 is a high-level diagram illustrating oscillators included in a substrate of the thermodynamic chip and mapping of the oscillators to logical neurons of the thermodynamic chip, according to some embodiments.

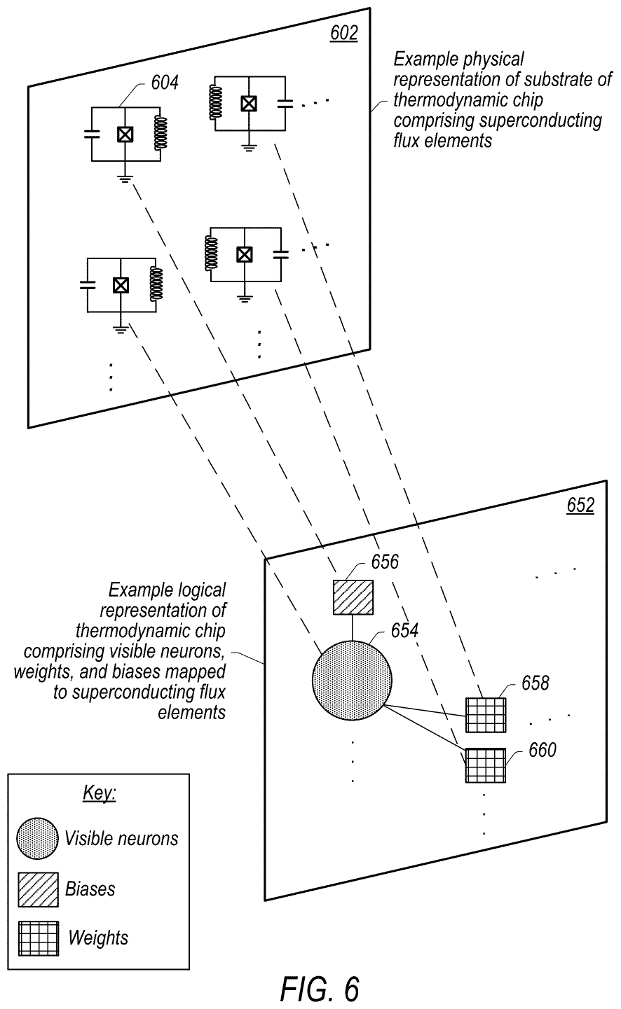

In some embodiments, a substrate 502 may be included in a thermodynamic chip(s), such as any one of the thermodynamic chips described above, such as thermodynamic chip(s) 100. Oscillators 504 of substrate 502 may be mapped in a logical representation 552 to neurons 554, as well as weights and biases (shown in FIG. 6). In some embodiments, oscillators 504 may include oscillators with potentials ranging from a single well potential to a dual-well potential and may be mapped to visible neurons, weights, and biases.

In some embodiments, Josephson junctions and/or superconducting quantum interference devices (SQUIDS) may be used to implement and/or excite/control the oscillators 504. In some embodiments, the oscillators 504 may be implemented using superconducting flux elements (e.g., qubits). In some embodiments, the superconducting flux elements may physically be instantiated using a superconducting circuit built out of coupled nodes comprising capacitive, inductive, and Josephson junction elements, connected in series or parallel, such as shown in FIG. 5 for oscillator 504. However, in some embodiments, generally speaking various non-linear flux loops may be used to implement the oscillators 504, such as those having single-well potential, double-well potential, or various other potentials, such as a potential somewhere between a single-well potential and a double-well potential.

FIG. 6 is an additional high-level diagram illustrating oscillators included in a substrate of the thermodynamic chip mapped to logical neurons, weights, and biases of a given neuro-thermodynamic computing system, according to some embodiments.

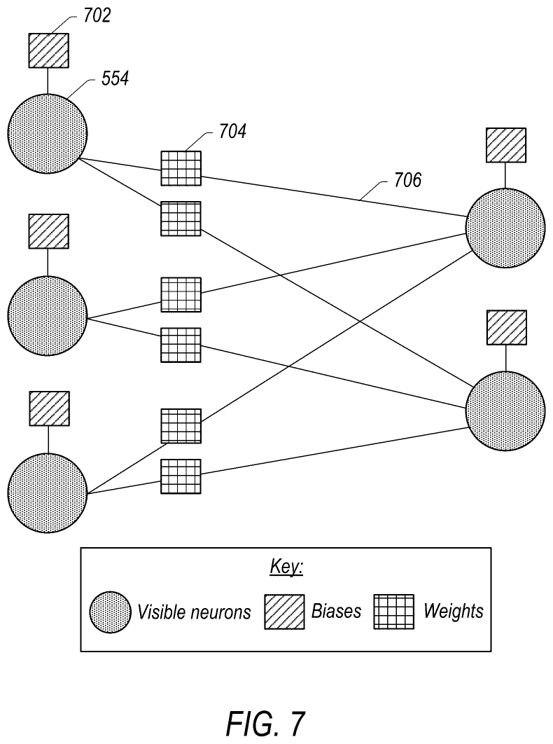

While weights and biases are not shown in FIG. 5 for ease of illustration, respective ones of the visible neurons 554 of FIG. 5 may each have an associated bias, and edges connecting the neurons 554 may have associated weights. For example, FIG. 7 illustrates an arrangement of five visible neurons along with associated weights and biases. Each of the weights and biases (such as those shown in FIG. 6) may be mapped to oscillators in the thermodynamic chip, as well as the visible (and non-visible) neurons being mapped to oscillators in the thermodynamic chip. For example, FIG. 6 shows a portion of a thermodynamic chip, wherein weights and biases associated with a given neuron 654 are shown. For example, bias 656 may be a bias value for visible neuron 654 and weights 658 and 660 may be weights for edges formed between visible neuron 654 and other visible neurons of the thermodynamic chip. As shown in FIG. 6, each of the chip elements (visible neuron 654, bias 656, weight 658, and weight 660) may be mapped to separate ones of oscillators 604. This may allow the visible neurons (and/or hidden neurons), weights, and biases to have independent degrees of freedom within a given thermodynamic chip that can separately evolve.

In some embodiments, oscillators associated with weights and biases, such as bias 656 and weights 658 and 660, may be allowed to evolve during a training phase and may be held nearly constant during an inference phase. For example, in some embodiments, larger “masses” may be used for the weights and biases such that the weights and biases evolve more slowly than the visible neurons. This may have the effect of holding the weight values and the bias values nearly constant during an evolution phase used for generating inference values.

FIG. 7 illustrates example couplings between visible neurons, weights, and biases (e.g., synapses) of a thermodynamic chip, according to some embodiments.

In some embodiments, visible neurons, such as visible neurons 554, may be linked via connected edges 706. Furthermore, as shown in FIG. 7, such visible neurons may additionally be linked to corresponding biases (e.g., synapses), such as biases 702, and to weights (e.g., synapses), such as weights 704. Recall that neurons, weights, and biases are logical representations of physical oscillators. Such that when describing neurons, weights, and biases in FIG. 7 it should be understood that these elements are implemented using oscillators and couplings as shown in FIG. 5.

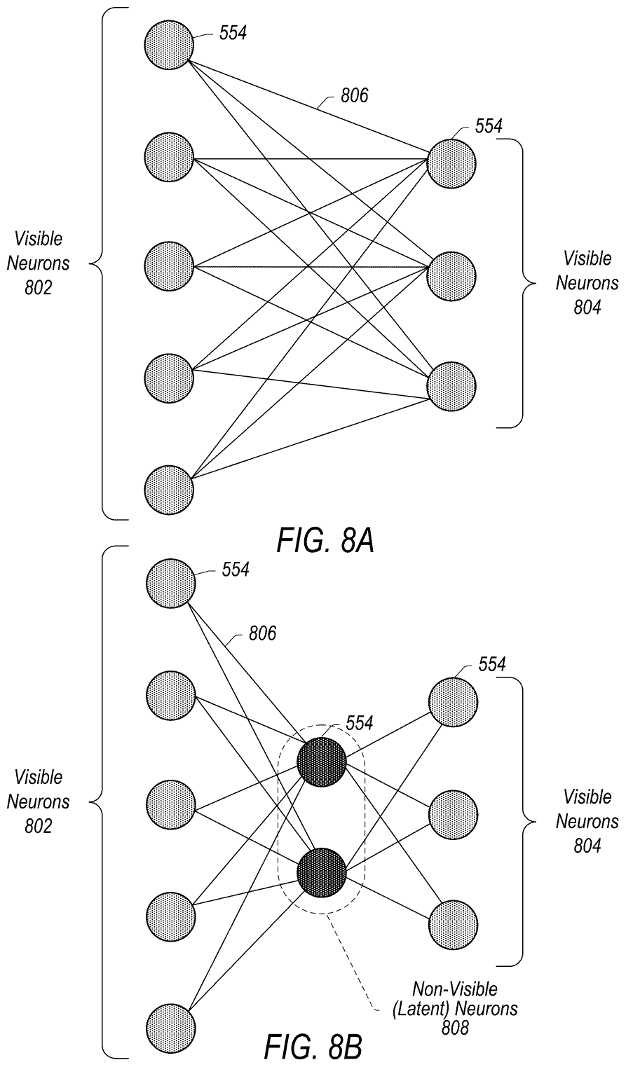

FIG. 8A illustrates example couplings between visible neurons of a thermodynamic chip, according to some embodiments.

In some embodiments, input neurons and output neurons, such as visible neurons 802 and visible neurons 804, may be directly linked via connected edges 806. As shown in FIG. 8A, a given visible neuron 802 of the five shown in the figure is connected, via edges 806, to each of the respective three visible neurons 804. A person having ordinary skill in the art should understand that FIG. 8A is meant to represent example embodiments of a graph architecture implemented using a thermodynamic chip that may be applied for image classification, for example, and that specific numbers of visible neurons 802 and/or visible neurons 804 shown in the figure are not meant to be restrictive. Additional configurations combining more/less visible neurons 802 and/or visible neurons 804 are also encompassed by the discussion herein. In addition, recall that neurons are logical representations of physical oscillators, such that, when describing neurons in FIGS. 8A and 8B, it should be understood that neurons and edges are implemented using oscillators and couplings as shown in FIG. 7.

FIG. 8B illustrates example couplings between visible neurons and non-visible neurons (e.g., hidden neurons) of a thermodynamic chip, according to some embodiments.

In some embodiments, FIG. 8B may resemble additional example embodiments of an architecture implemented using a thermodynamic chip. As shown in the figure, additional non-visible neurons 808 may be used, which are respectively coupled, via edges 806, to both visible neurons 802 and to visible neurons 804. Note that while the non-visible neurons are “not visible” from the perspective of inputs and outputs, the non-visible neurons may each correspond to a given oscillator, such as a given oscillator 804 as shown in FIG. 5. In addition, it may be noted that, in some embodiments that make use of non-visible neurons, no direct connections, via edges 806, may be implemented between visible neurons 802 and visible neurons 804, but rather connections are routed firstly via non-visible neurons 808, as shown in FIG. 18B. Couplings between visible and non-visible neurons may be additionally referred to herein as “layers” of a given architecture that is implemented using a thermodynamic chip, according to some embodiments.

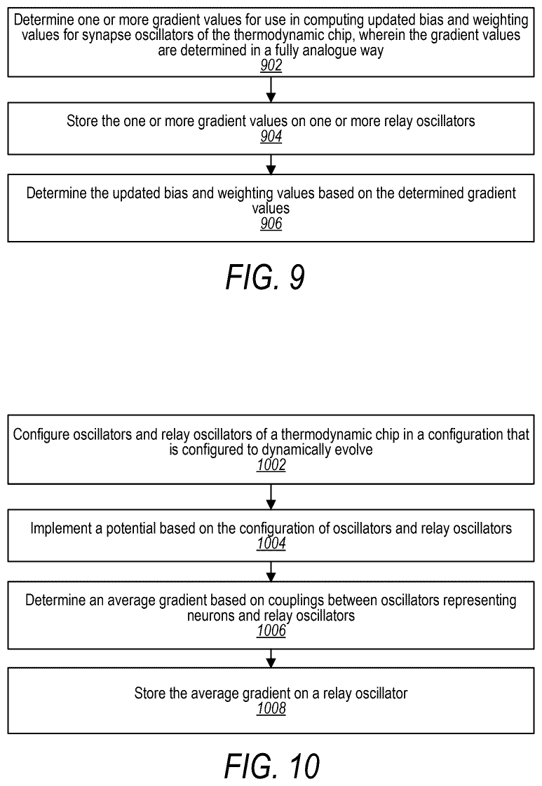

FIG. 9 is a flowchart illustrating an example process of determining updated synapse values based on determined gradient values, according to some embodiments.

In some embodiments, it is desired to determine updated bias and weighting values of synapse parameters. For example, a general method to determine such updates may include the following steps. Determine one or more gradient values for use in computing updated bias and weighting values for synapse oscillators of the thermodynamic chip, wherein the gradient values are determined in a fully analogue way 902. Store the one or more gradient values on one or more relay oscillators 904.

FIG. 10 is a flowchart illustrating an example process of configuring oscillators and relay oscillators of a thermodynamic chip to determine and store gradient terms used to update synapse parameters, according to some embodiments.

In some embodiments, an average gradient may be stored on a relay oscillator. For example, a method to store gradient values may include the following steps. Configure oscillators and relay oscillators of a thermodynamic chip in a configuration that is configured to dynamically evolve 1002. Implement a potential based on the configuration of oscillators and relay oscillators 1004. Determine an average gradient based on couplings between oscillators representing neurons and relay oscillators 1006. Store the average gradient on a relay oscillator 1008.

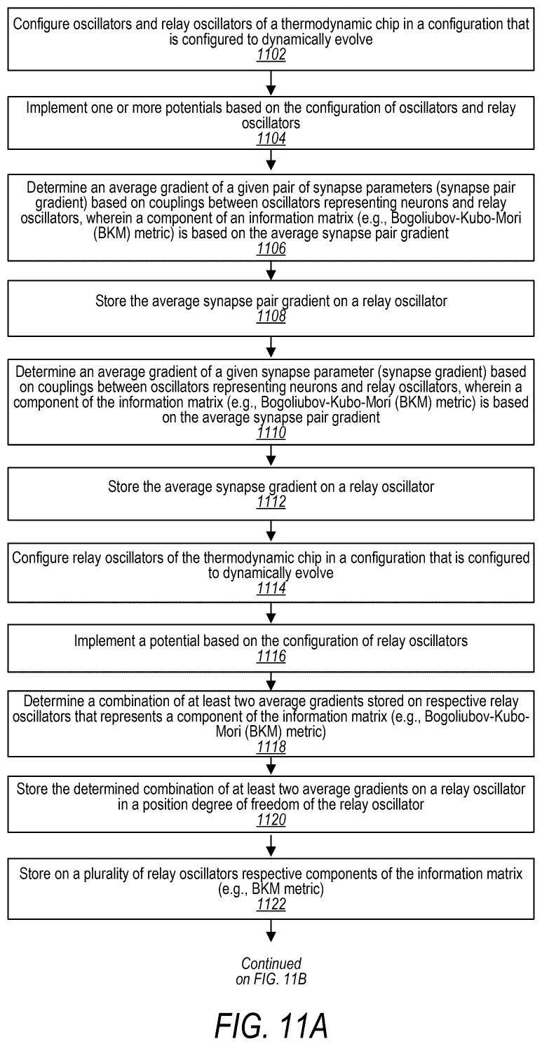

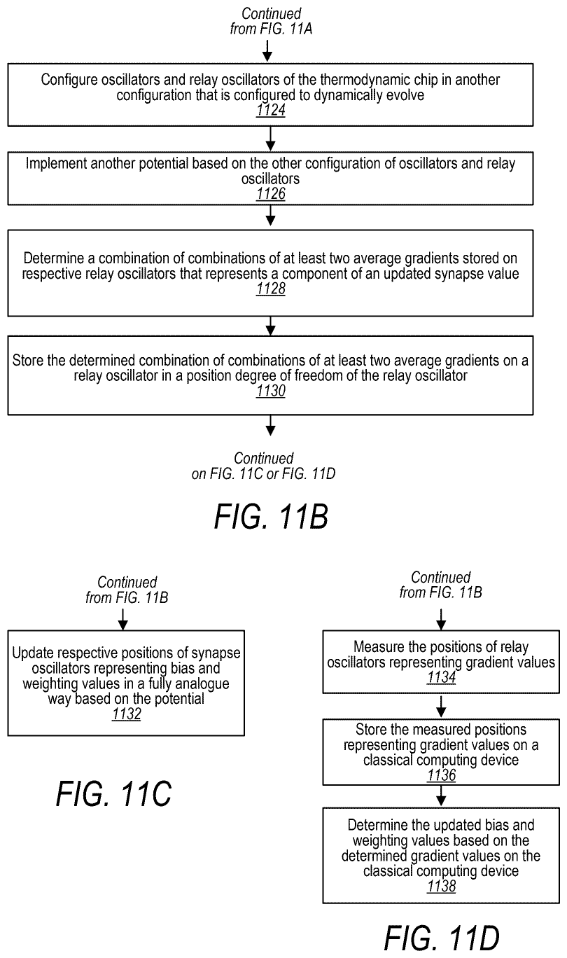

FIG. 11A is a flowchart illustrating an example process of determining multiple gradient terms and combining the gradient terms used to update synapse parameters, according to some embodiments.

In some embodiments, several steps are included in updating synapse parameters based on training data. For example, a method to store gradient terms used to update synapse values may include the following steps. Configure oscillators and relay oscillators of a thermodynamic chip in a configuration that is configured to dynamically evolve 1102. Implement one or more potentials based on the configuration of oscillators and relay oscillators 1104. Determine an average gradient of a given pair synapse parameters (synapse pair gradient) based on couplings between oscillators representing neurons and relay oscillators, wherein a component of an information matrix (e.g., Bogoliubov-Kubo-Mori (BKM) metric) is based on the average synapse pair gradient 1106. Store the average synapse pair gradient on a relay oscillator 1108. Determine an average gradient of a given synapse parameter (synapse gradient) based on couplings between oscillators representing neurons and relay oscillators, wherein a component of the information matrix (e.g., Bogoliubov-Kubo-Mori (BKM) metric) is based on the average synapse pair gradient 1110. Store the average synapse gradient on a relay oscillator 1112. Configure relay oscillators of the thermodynamic chip in a configuration that is configured to dynamically evolve 1114. Implement a potential based on the configuration of relay oscillators 1116. Determine a combination of at least two average gradients stored on respective relay oscillators that represents a component of the information matrix (e.g., Bogoliubov-Kubo-Mori (BKM) metric) 1118. Store the determined combination of at least two average gradients on a relay oscillator in a position degree of freedom of the relay oscillator 1120. Store on a plurality of relay oscillators respective components of the information matrix (e.g., BKM metric) 1122.

FIG. 11B is a continuation of a flowchart in FIG. 11A, according to some embodiments.

In some embodiments, the flowchart of 11A may continue with the following steps. Configure oscillators and relay oscillators of the thermodynamic chip in another configuration that is configured to dynamically evolve 1124. Implement another potential based on the other configuration of oscillators and relay oscillators 1126. Determine a combination of combinations of at least two average gradients stored on respective relay oscillators that represents a component of an updated synapse value 1128. Store the determined combination of combinations of at least two average gradients on a relay oscillator in a position degree of freedom of the relay oscillator 1130.

FIG. 11C is a flowchart illustrating an example process of continuing a flowchart in FIG. 11B, wherein bias and weighting values are updated in a fully analogue way, according to some embodiments.

In some embodiments, updating synapse values may comprise a fully analogue protocol. For example, the flowchart of 11B may continue with the step Update respective positions of synapse oscillators representing bias and weighting values in a fully analogue way based on the potential 1132.

FIG. 11D is a flowchart illustrating an example process of continuing a flowchart in FIG. 11B, wherein bias and weighting values are updated using a classical computing device, according to some embodiments.

In some embodiments, updating synapse values may comprise utilizing a classical computing device. For example, the flowchart of 11B may continue with the following steps. Measure the positions of relay oscillators representing gradient values 1134. Store the measured positions representing gradient values on a classical computing device 1136. Determine the updated bias and weighting values based on the determined gradient values on the classical computing device 1138.

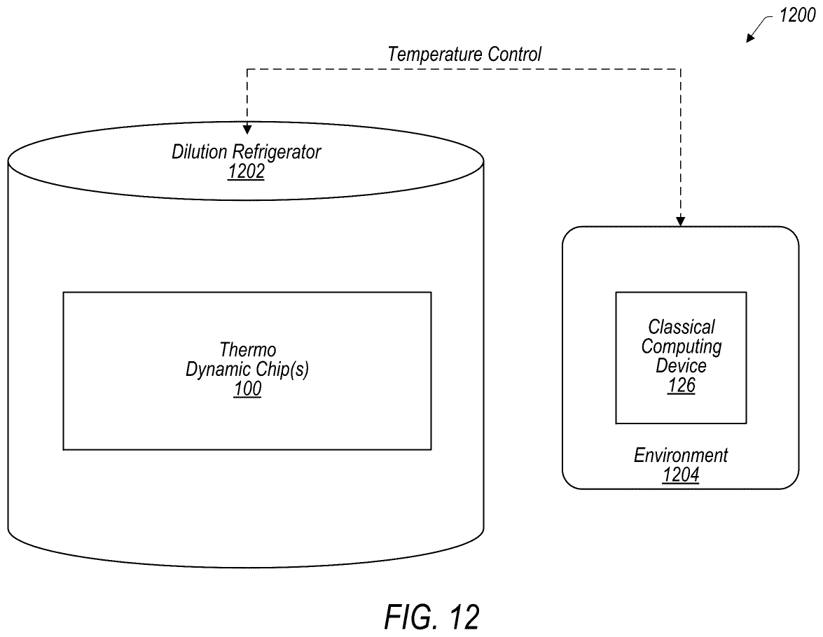

FIG. 12 is high-level diagram illustrating an example architecture of a self-learning neuro-thermodynamic computer comprising a thermodynamic chip included in a dilution refrigerator and coupled to a classical computing device in an environment external to the dilution refrigerator, according to some embodiments.

In some embodiments, a neuro-thermodynamic computing system 1200 (as shown in FIG. 12) may be used to implement the various embodiments shown in FIGS. 1-11 and may include a thermodynamic chip(s) 100 placed in a dilution refrigerator 1202. In some embodiments, classical computing device 126 may control temperature for dilution refrigerator 1202, and/or perform other tasks, such as helping to drive a pulse drive to change respective hyperparameters of the given system and/or perform measurements, such as those shown in FIGS. 1-11. Also, the classical computing device 126 may perform other simple computing operations, such as are needed to determine updated weights and biases based a first set of measurements of synapse oscillators subsequent to (or during) a clamped evolution and based on a second set of measurements of synapse oscillators subsequent to (or during) an un-clamped evolution.

In some embodiments, classical computing device 126 may include one or more devices such as a field-programmable gate array (FPGA), an application specific integrated circuit (ASIC), and/or other devices that may be configured to interact and/or interface with a thermodynamic chip within the architecture of neuro-thermodynamic computer 1200. For example, such devices may be used to tune hyperparameters of the given thermodynamic system, etc. as well as perform part of the calculations necessary to determine updated weights and biases.

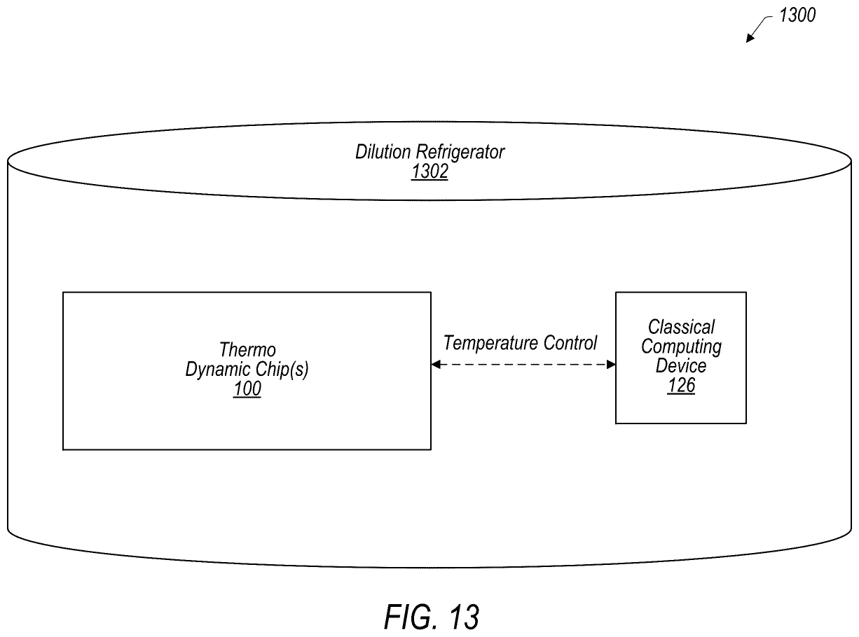

FIG. 13 is high-level diagram illustrating an example neuro-thermodynamic computer comprising a thermodynamic chip included in a dilution refrigerator and coupled to a classical computing device that is also included in the dilution refrigerator, according to some embodiments.

As another alternative, in some embodiments, a classical computing device used in a neuro-thermodynamic computer, such as in neuro-thermodynamic computer 1300, may be included in a dilution refrigerator with the thermodynamic chip. For example, neuro-thermodynamic computer 1300 includes both thermodynamic chip(s) 100 and classical computing device 126 in dilution refrigerator 1302.

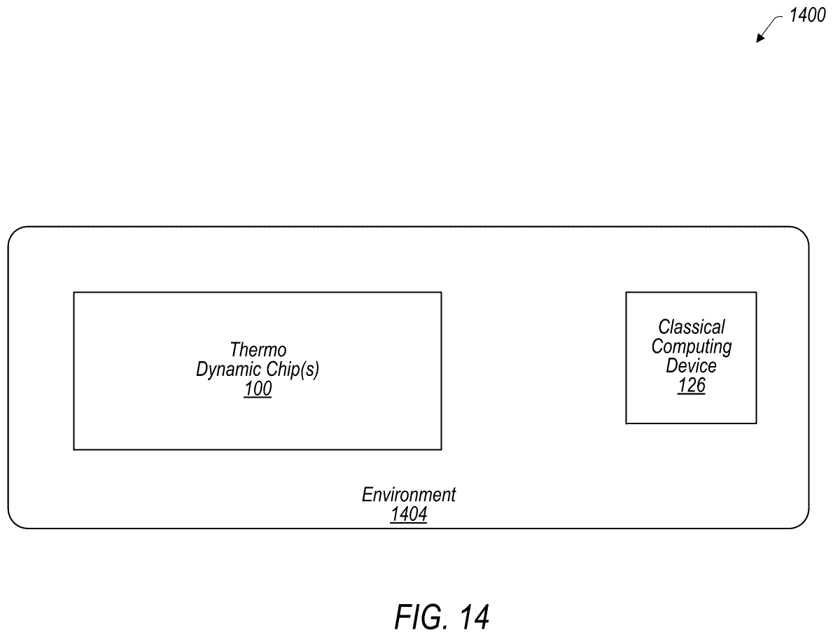

FIG. 14 is high-level diagram illustrating an example neuro-thermodynamic computer comprising a thermodynamic chip coupled to a classical computing device in an environment other than a dilution refrigerator, according to some embodiments.

Also, in some embodiments, a neuro-thermodynamic computer, such as neuro-thermodynamic computer 1400, may be implemented in an environment other than a dilution refrigerator. For example, neuro-thermodynamic computer 1400 includes thermodynamic chip(s) 100 and classical computing device 126, in environment 1404. In some embodiments, environment 1404 may be temperature controlled and, the classical computing device (or other device) may control the temperature of environment 1404 in order to achieve a given level of evolution according to Langevin dynamics.

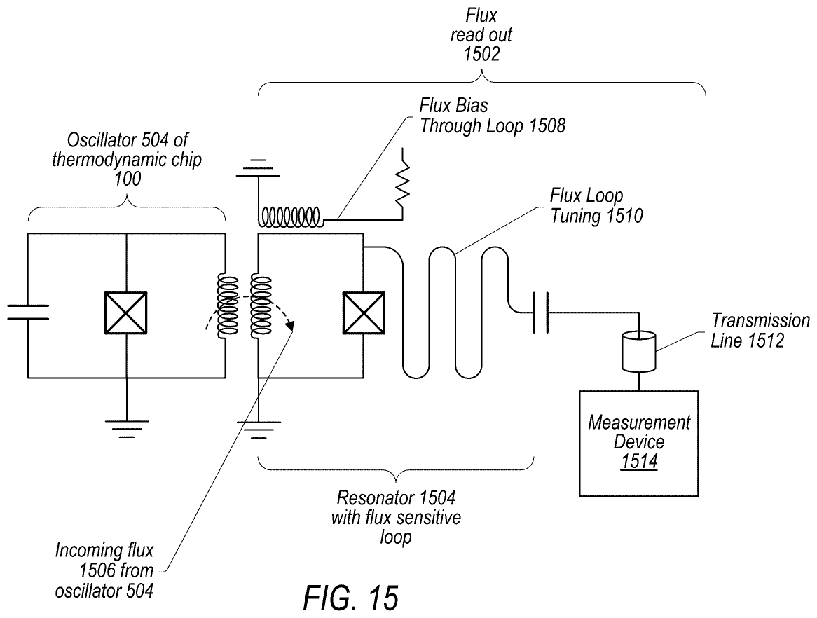

FIG. 15 illustrates an example apparatus for measuring positions of oscillators of a thermodynamic chip using a flux read-out device, according to some embodiments.

In some embodiments, a resonator with a flux sensitive loop, such as resonator 1504 of flux readout apparatus 1502 may be used to measure flux and therefore position of an oscillator 1504 of thermodynamic chip 102. Note that flux is the analog of position for the oscillators used in thermodynamic chip 102. The flux of oscillator 1504 is measured by flux readout device 1502. For example, if the inductance of oscillator 1504 changes, it will also cause a change in the inductance of resonator 1504. This in turn causes a change in the frequency at which resonator 1504 resonates. In some embodiments, measurement device 1514 detects such changes in resonator frequency of resonator 1504 by sending a signal wave through the resonator 1504. The response wave that can be measured at measurement device 1514, will be altered due to the change in resonator frequency of resonator 1504, which can be measured and calibrated to measure the flux of oscillator 504, and therefore the position of its corresponding neuron or synapse that is coded using that oscillator.

More specifically, in some embodiments, incoming flux 1506 from resonator 1504 is sensed by the inductor of resonator 1504, wherein flux tuning loop 1510 is used to tune the flux sensed by resonator 1504. Flux bias 1508 also biases the flux to flow through resonator 1504 towards transmission line 1512. In some embodiments, transmission line 1512 may carry the signal outside of a dilution refrigerator, such as dilution refrigerator 1202 shown in FIG. 12. Also, in some embodiments, transmission line 1512 may carry the signal to a classical computing device located within the dilution refrigerator, such as is shown for dilution refrigerator 1302 in FIG. 13. Measurement device 1514 may then be used to measure the signal representing the flux and may provide a flux measurement value and/or provide a position measurement value.

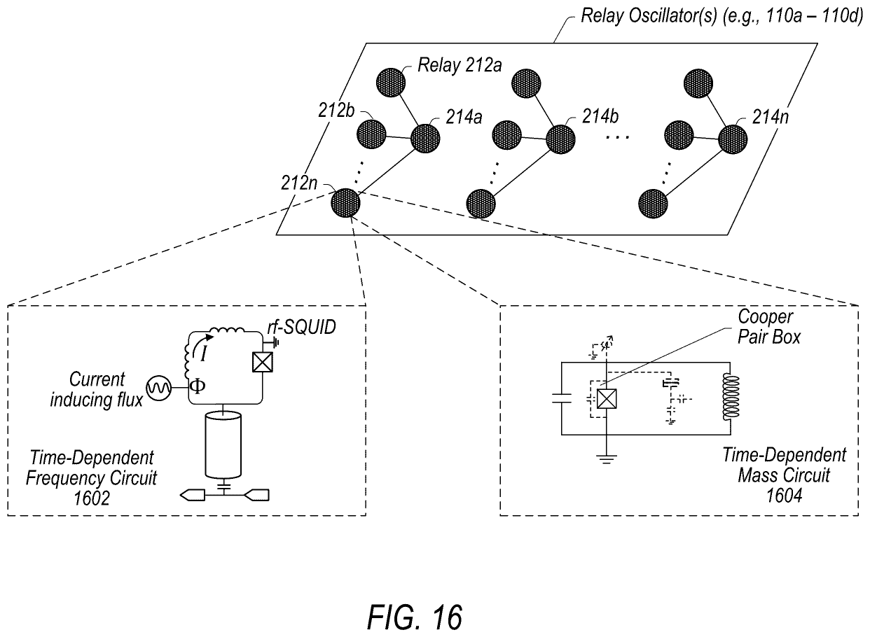

FIG. 16 is a diagram illustrating hardware components that may be used to implement oscillators of a first and second energy-based models (EBMs), as well as two different example hardware configurations of a relay oscillator that have a time-dependent mass or a time-dependent frequency, respectively, according to some embodiments.

Two different example hardware configurations of a relay oscillator that have a time-dependent mass or a time-dependent frequency, respectively are given, according to some embodiments.

Superconducting circuits may be used to implement relay oscillators. For example, circuit 1602 shows an example implementation circuit for the relay oscillator 212n, wherein the circuit 1602 implements a time-dependent frequency that can be controlled by a controller. As another alternative, circuit 1604 shows an example implementation circuit for the relay oscillator 212n, wherein the circuit 1604 implements a time-dependent mass that can be controlled by a controller.

### Illustrative Computer System

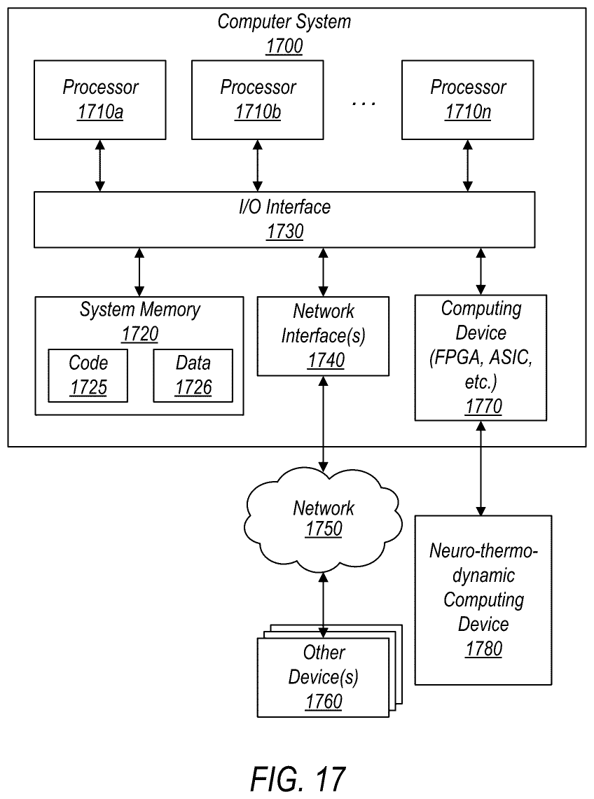

FIG. 17 is a block diagram illustrating an example computer system that may be used in at least some embodiments. In some embodiments, the computing system shown in FIG. 17 may be used, at least in part, to implement any of the techniques described above in FIGS. 1-16. Furthermore, computer system 1700 may be configured to interact and/or interface with self-learning neuro-thermodynamic computing device 1780, according to some embodiments.

In the illustrated embodiment, computer system 1700 includes one or more processors 1710 coupled to a system memory 1720 (which may comprise both non-volatile and volatile memory modules) via an input/output (I/O) interface 1730. Computer system 1700 further includes a network interface 1740 coupled to I/O interface 1730. Classical computing functions may be performed on a classical computer system, such as computing computer system 1700.

Additionally, computer system 1700 includes computing device 1770 coupled to thermodynamic chip 1780. In some embodiments, computing device 1770 may be a field programmable gate array (FPGA), application specific integrated circuit (ASIC) or other suitable processing unit. In some embodiments, computing device 1770 may be a similar computing device as described in FIGS. 1-16, such as classical computing devices 104. In some embodiments, neuro thermodynamic computing device 1780 may be a similar neuro thermodynamic computing device as described in FIGS. 1-16, such as neuro thermodynamic computing devices implemented using thermodynamic chip(s) 100.

In various embodiments, computer system 1700 may be a uniprocessor system including one processor 1710, or a multiprocessor system including several processors 1710 (e.g., two, four, eight, or another suitable number). Processors 1710 may be any suitable processors capable of executing instructions. For example, in various embodiments, processors 1710 may be general-purpose or embedded processors implementing any of a variety of instruction set architectures (ISAs), such as the x86, PowerPC, SPARC, or MIPS ISAs, or any other suitable ISA. In multiprocessor systems, each of processors 1710 may commonly, but not necessarily, implement the same ISA. In some implementations, graphics processing units (GPUs) may be used instead of, or in addition to, conventional processors.

System memory 1720 may be configured to store instructions and data accessible by processor(s) 1710. In at least some embodiments, the system memory 1720 may comprise both volatile and non-volatile portions; in other embodiments, only volatile memory may be used. In various embodiments, the volatile portion of system memory 1720 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magneto resistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 1720 as code 1725 and data 1726.

In some embodiments, I/O interface 1730 may be configured to coordinate I/O traffic between processor 1710, system memory 1720, computing device 1770, and any peripheral devices in the computer system, including network interface 1740 or other peripheral interfaces such as various types of persistent and/or volatile storage devices. In some embodiments, I/O interface 1730 may perform any necessary protocol, timing or other data transformations to convert data signals from one component (e.g., system memory 1720) into a format suitable for use by another component (e.g., processor 1710). In some embodiments, I/O interface 1730 may include support for devices attached through various types of peripheral buses, such as a variant of the Peripheral Component Interconnect (PCI) bus standard or the Universal Serial Bus (USB) standard, for example. In some embodiments, the function of I/O interface 1730 may be split into two or more separate components, such as a north bridge and a south bridge, for example. Also, in some embodiments some or all of the functionality of I/O interface 1730, such as an interface to system memory 1720, may be incorporated directly into processor 1710.

Network interface 1740 may be configured to allow data to be exchanged between computing device 1700 and other devices 1760 attached to a network or networks 1750, such as other computer systems or devices. In various embodiments, network interface 1740 may support communication via any suitable wired or wireless general data networks, such as types of Ethernet network, for example. Additionally, network interface 1740 may support communication via telecommunications/telephony networks such as analog voice networks or digital fiber communications networks, via storage area networks such as Fibre Channel SANs, or via any other suitable type of network and/or protocol.

In some embodiments, system memory 1720 may represent one embodiment of a computer-accessible medium configured to store at least a subset of program instructions and data used for implementing the methods and apparatus discussed in the context of FIG. 1 through FIG. 19. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computer system 1700 via I/O interface 1730. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computer system 1700 as system memory 1720 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 1740. Portions or all of multiple computing devices such as that illustrated in FIG. 17 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computer system”, as used herein, refers to at least all these types of devices, and is not limited to these types of devices.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures above and the Appendix below and described herein represent exemplary embodiments of methods. The methods may be implemented in software, hardware, or a combination thereof. The order of method may be changed, and various elements may be added, reordered, combined, omitted, modified, etc.

It will also be understood that, although the terms first, second, etc., may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

Various modifications and changes may be made as would be obvious to a person skilled in the art having the benefit of this disclosure. It is intended to embrace all such modifications and changes and, accordingly, the above description and the Appendix below is to be regarded in an illustrative rather than a restrictive sense.

What is claimed is:

1. A system, comprising:
one or more thermodynamic chips, comprising oscillators, wherein:
respective ones of the oscillators are configured to be coupled with one another in one or more configurations that correspond to one or more engineered Hamiltonians, wherein:
a first set of the oscillators of the one or more thermodynamic chips represent a first set of neurons; and
a second set of the oscillators of the one or more thermodynamic chips represent synapse values for the first set of neurons; and
a set of relay oscillators configured to:
couple to respective ones of the first set of oscillators representing the first set of neurons that are coupled to respective ones of the second set of oscillators representing the synapse values for the first set of neurons; and
store gradient terms of the engineered Hamiltonian with respect to synapse values in a position degree of freedom of one or more relay oscillators of the set of relay oscillators; and
wherein the system is configured to update the synapse values for the first set of neurons based on the gradient terms.

2. The system of claim 1, wherein the set of relay oscillators comprises:
a first set of one or more first relay oscillators configured to store an average gradient of a given pair of oscillators of the second set of oscillators representing synapse values (synapse pair gradient) based on couplings between oscillators of the first set of oscillators and relay oscillators, wherein a component of an information matrix is based on the average synapse pair gradient.

3. The system of claim 2, further comprising:
one or more classical computing devices, wherein:
one or more given relay oscillators of the set of relay oscillators couple, one set at a time, to respective sets of the first set of oscillators representing the neurons (neuron oscillators) for pairs of a plurality of respective pairs of the second set of oscillators representing the synapse values (synapse oscillators) to relay a plurality of average synapse pair gradients for the plurality of respective synapse oscillators; and
the one or more classical computing devices are configured to receive and store, one at a time, the plurality of average synapse pair gradients.

4. The system of claim 2, further comprising:
a plurality of first relay oscillators, wherein respective ones of the first relay oscillators are configured to respectively store average synapse pair gradients in a fully analogue way.

5. The system of claim 2, wherein the set of relay oscillators comprises:
a second set of one or more second relay oscillators configured to store an average gradient of a given oscillator of the second set of oscillators representing synapse values (synapse gradient), wherein a component of the information matrix is based on the average synapse gradient.

6. The system of claim 5, wherein the set of relay oscillators comprises:
a third set of one or more third relay oscillators configured to compute and store information matrix elements based on the one or more first relay oscillators and the one or more second relay oscillators.

7. The system of claim 1, wherein the set of relay oscillators comprises:
a first set of one or more first relay oscillators configured to compute and store a gradient corresponding to a positive phase term based on couplings between oscillators of the thermodynamic chip and relay oscillators.

8. The system of claim 7, wherein the set of relay oscillators comprises:
a second set of one or more second relay oscillators configured to compute and store a gradient corresponding to a combination of the gradient corresponding to the positive phase term and a gradient corresponding to a negative phase term based on couplings between relay oscillators.

9. The system of claim 1, wherein the set of relay oscillators comprises:
a first set of one or more first relay oscillators, wherein a given first relay oscillator is configured to evaluate and store a combination of gradients, wherein the gradients to be combined correspond to:
information matrix elements;
a positive phase term; and
a negative phase term; and
wherein the combined gradient is used to update oscillators of the second set of oscillators representing the synapse values.

10. A method of training a thermodynamic chip, the method comprising:
determining one or more gradient values for use in computing updated bias and weighting values for synapse oscillators of the thermodynamic chip, wherein the gradient values are determined in a fully analogue way;
storing the one or more gradient values on one or more relay oscillators; and
determining the updated bias and weighting values based on the determined gradient values.

11. The method of claim 10, further comprising:
configuring oscillators and relay oscillators of the thermodynamic chip in a configuration that is configured to dynamically evolve;
implementing a potential based on the configuration of oscillators and relay oscillators;
determining an average gradient of a given pair of oscillators representing synapse values (synapse pair gradient) based on couplings between oscillators representing neurons and relay oscillators, wherein a component of an information matrix is based on the average synapse pair gradient; and
storing the average synapse pair gradient on a relay oscillator.

12. The method of claim 10, further comprising:
configuring oscillators and relay oscillators of the thermodynamic chip in a configuration that is configured to dynamically evolve;
implementing a potential based on the configuration of oscillators and relay oscillators;
determining an average gradient of a given oscillators representing a given synapse value (synapse gradient) based on couplings between oscillators representing neurons and relay oscillators, wherein a component of an information matrix is based on the average synapse pair gradient; and
storing the average synapse gradient on a relay oscillator.

13. The method of claim 10, further comprising:
configuring relay oscillators of the thermodynamic chip in a configuration that is configured to dynamically evolve;
implementing a potential based on the configuration of relay oscillators;
determining a combination of at least two average gradients stored on respective relay oscillators; and
storing the determined combination of at least two average gradients on a relay oscillator.

14. The method of claim 13, wherein:
the determined combination of at least two average gradients on a relay oscillator is stored in a position degree of freedom of the relay oscillator; and
the determined combination of at least two average gradients represents a component of an information matrix.

15. The method of claim 14, wherein:
a plurality of relay oscillators respectively store respective components of the information matrix.

16. The method of claim 13, further comprising:
configuring oscillators and relay oscillators of the thermodynamic chip in another configuration that is configured to dynamically evolve;
implementing another potential based on the other configuration of oscillators and relay oscillators;
determining a combination of combinations of at least two average gradients stored on respective relay oscillators; and
storing the determined combination of combinations of at least two average gradients on a relay oscillator.

17. The method of claim 16, wherein:
the determined combination of combinations of at least two average gradients stored on respective relay oscillators is stored in a position degree of freedom of the relay oscillator; and
the determined combination of combinations represents a component of an updated synapse value.

18. The method of claim 10, further comprising:
configuring oscillators and relay oscillators of the thermodynamic chip in a configuration that is configured to dynamically evolve;
implementing a potential based on the configuration of oscillators and relay oscillators; and
updating respective positions of synapse oscillators representing bias and weighting values in a fully analogue way based on the potential.

19. The method of claim 10, further comprising:
measuring the positions of relay oscillators representing gradient values;
storing the measured positions representing gradient values on a classical computing device; and
wherein, determining the updated bias and weighting values based on the determined gradient values is performed on the classical computing device.

20. A thermodynamic energy-based model training gadget, comprising:
a set of relay oscillators configured to:
couple to respective ones of a first set of oscillators representing a first set of neurons that are coupled to respective synapse parameter values for the first set of neurons, wherein the first set of oscillators are oscillators of an energy-based model for which synapse values are to be learned; and
store gradient terms with respect to synapse values in a position degree of freedom of one or more relay oscillators of the set of relay oscillators.

21. The system of claim 20, wherein the set of relay oscillators comprises:
a first set of one or more first relay oscillators configured to store an average gradient of a given pair of synapse parameters (synapse pair gradient) based on couplings between oscillators of the first set of oscillators and relay oscillators, wherein a component of an information matrix is based on the average synapse pair gradient.

22. The system of claim 21, further comprising:
a plurality of first relay oscillators, wherein respective ones of the first relay oscillators are configured to respectively store average synapse pair gradients in a fully analogue way.

23. The system of claim 21, wherein the set of relay oscillators comprises:
a second set of one or more second relay oscillators configured to store an average gradient of a given synapse parameter (synapse gradient), wherein a component of the information matrix is based on the average synapse gradient.

24. The system of claim 23, wherein the set of relay oscillators comprises:
a third set of one or more third relay oscillators configured to compute and store information matrix elements based on the one or more first relay oscillators and the one or more second relay oscillators.

25. The system of claim 20, wherein the set of relay oscillators comprises:
a first set of one or more first relay oscillators configured to compute and store a gradient corresponding to a positive phase term based on couplings between oscillators of the thermodynamic chip and relay oscillators.

26. The system of claim 25, wherein the set of relay oscillators comprises:
a second set of one or more second relay oscillators configured to compute and store a gradient corresponding to a combination of the gradient corresponding to the positive phase term and a gradient corresponding to a negative phase term based on couplings between relay oscillators.

27. The system of claim 20, wherein the set of relay oscillators comprises:
a first set of one or more first relay oscillators, wherein a given first relay oscillator is configured to evaluate and store a combination of gradients, wherein the gradients to be combined correspond to:
information matrix elements;
a positive phase term; and
a negative phase term; and
wherein the combined gradient is used to update synapse parameter values.

28. The system of claim 20, wherein:
the respective gradient terms correspond to respective expectation values of respective relay oscillators.

29. One or more non-transitory, computer-readable, storage media storing program instructions that, when executed on or across one or more processors, cause the one or more processors to:
receive, from one or more relay oscillators, gradient terms with respect to synapse values represented by oscillators of a thermodynamic chip, wherein the oscillators are part of an energy based model, wherein the energy based model comprises oscillators representing neurons and oscillators representing synapses;
determine an updated synapse value based on the received gradient terms;
update the synapse values represented by oscillators of the thermodynamic chip based on the gradient terms received.
